(19) United States
(12) Patent Application Publication
(10) Pub. No.: US 2026/0361774 A1
(43) Pub. Date: Nov. 12, 2026

(54) Internet Protocol Multimedia Subsystem Voice Services Over a Narrowband Internet-of-Things Satellite Non-Terrestrial Network

(71) Applicant: Skylo Technologies, Inc., Mountain View, CA (US)

(72) Inventors: Peng Tan, Newmarket (CA); Meghna Agrawal, Cupertino, CA (US); Andrew Nuttall, Mountain View, CA (US); Thaha Mohammed, Espoo (FI); Anteneh Adem, Espoo (FI)

(73) Assignee: Skylo Technologies, Inc., Mountain View, CA (US)

(21) Appl. No.: 19/667,963

(22) Filed: May 5, 2026

Related U.S. Application Data
(60) Provisional application No. 63/801,313, filed on May 7, 2025.

(51) Int. Cl. H04L 65/1016; H04L 5/00; H04L 65/1069; H04L 65/1073; H04L 65/1104; H04W 28/02; H04W 84/06

(52) U.S. Cl. CPC H04L 65/1016; H04L 5/0053; H04L 65/1069; H04L 65/1073; H04L 65/1104; H04W 28/0268; H04W 84/06

(57) ABSTRACT

Apparatuses, methods, and systems for supporting IP Multimedia Subsystem (IMS) voice services over a Narrowband Internet-of-things (NB-IoT) Satellite Non-Terrestrial Network (NTN). One method includes establishing for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device, wherein a wireless device is configured to support IMS voice communication over the NB-IoT satellite NTN.

### RELATED PATENT APPLICATIONS

This patent application claims the benefit of U.S. Provisional Patent Application Ser. No. 63/801,313 filed May 7, 2025, which is herein incorporated by reference.

### FIELD OF THE DESCRIBED EMBODIMENTS

The described embodiments relate generally to wireless communications. More particularly, the embodiments described relate to systems, methods, and apparatuses for Internet Protocol multimedia subsystem voice services over a narrowband internet-of-things satellite non-terrestrial network.

### BACKGROUND

Internet Protocol (IP) Multimedia Subsystem (IMS) voice service over NB-IoT NTN via GEO satellite has the potential to extend standardized voice communication services to remote and underserved geographic regions that lack terrestrial network infrastructure. This capability is critical for enabling basic voice connectivity, supporting emergency communication services, and ensuring compliance with applicable regulatory requirements. It also aligns with broader objectives to integrate 3GPP-compliant mobile communication services with satellite-based systems.

However, current systems do not support IMS voice over NB-IoT operating via GEO satellite within Non-Terrestrial Networks (NTN), primarily due to several technical limitations. As outlined in Annex M of 3GPP TS 23.401, key core network mobility management functions are not available when NB-IoT is employed as the radio access technology. These limitations include the absence of essential parameters such as the “IMS voice over Packet-Switched (PS) session supported indication” and “Voice domain preference and UE usage setting.” Furthermore, critical functionalities, such as support for IMS emergency sessions, restricted local operator services, multimedia priority services, and control of enhanced coverage usage for voice-centric user equipment (UE), are also not supported. In addition, NB-IoT lacks support for Guaranteed Bit Rate (GBR) bearers and dedicated bearer setup, both of which are vital for ensuring the Quality of Service (QoS) required for voice communications.

The Session Initiation Protocol (SIP), typically used for IMS session setup, is also poorly suited to operation over NB-IoT NTN with GEO satellite connectivity. Challenges include high signaling overhead (commonly 500 to 1,500 bytes per message), multiple required round-trip messages for session establishment (e.g., INVITE, 180 Ringing, 200 OK, ACK), and the lack of SIP stack support on many NB-IoT devices. These factors contribute to excessive signaling latency and complexity, particularly problematic in high-latency satellite environments.

It is desirable to have methods, apparatuses, and systems for IP multimedia subsystem voice services over a narrowband internet-of-things satellite non-terrestrial network.

### SUMMARY

An embodiment includes a method for supporting IP Multimedia Subsystem (IMS) voice services over a Narrowband Internet-of-things (NB-IoT) Satellite Non-Terrestrial Network (NTN), including establishing, by a core network of the NB-IoT satellite NTN, for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device, wherein a wireless device is configured to support IMS voice communication over the NB-IoT satellite NTN, including establishing, by the wireless device, the two separate DRBs for an IMS voice session including the first DRB for transporting signaling traffic and a second DRB for transporting voice media packets, sending, by a non-IP data transport of the wireless device, the signaling traffic and/or the voice media packets, configuring, by the wireless device, a radio link control (RLC) acknowledged mode for the signaling traffic and an unacknowledged mode or the voice media packets, and initiating, by a control module of the wireless device, an IMS session setup using signaling, wherein the signal includes messages to support call set up, release, modifications, and call registration, and wherein the signaling traffic includes data streams that include the messages.

Another embodiment includes a Narrowband Internet-of-things (NB-IoT) Satellite Non-Terrestrial Network (NTN) that includes a core network, and a base station. The core network is configured to establish for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device. A wireless device is configured to establish the two separate DRBs for an IMS voice session including the first DRB for transporting signaling traffic and a second DRB for transporting voice media packets, send, by a non-IP data transport of the wireless device, the signaling traffic and/or the voice media packets, configure a radio link control (RLC) acknowledged mode for the signaling traffic and an unacknowledged mode or the voice media packets, and initiate, by a control module of the wireless device, an IMS session setup using signaling, wherein the signal includes messages to support call set up, release, modifications, and call registration, and wherein the signaling traffic includes data streams that include the messages.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a Narrowband Internet-of-things (NB-IoT) Satellite Non-Terrestrial Network (NTN) that includes a core network, a base station, and a wireless device communicating with the base station through a satellite, according to an embodiment.

FIG. 2 is a flow chart that includes steps of a method of a Narrowband Internet-of-things (NB-IoT) Satellite Non-Terrestrial Network (NTN), according to an embodiment.

FIG. 3 shows an NB-IoT NTN), according to another embodiment.

FIG. 4 shows a structure of information elements, according to an embodiment.

FIG. 5 shows a timestamp IE, according to an embodiment.

FIG. 6 shows a dummy IE, according to an embodiment.

FIG. 7 shows APE encoding with three IEs, according to an embodiment.

FIG. 8 shows APE encoding with a dummy IE, according to an embodiment.

FIG. 9 shows a flow for MO call procedures, according to an embodiment.

FIG. 10 shows a flow for MT call procedures, according to another embodiment.

FIG. 11 shows an NB-IoT NTN), according to another embodiment.

### DETAILED DESCRIPTION

The embodiments described include methods, apparatuses, and systems for IP multimedia subsystem voice services over a narrowband internet-of-things satellite non-terrestrial network.

To address the challenges described, the embodiments described provide methods, apparatuses, and systems that implement a set of enhancements to enable IMS voice over NB-IoT via satellite, including mechanisms for supporting appropriate QoS. These enhancements are designed to address the specific challenges posed by the high latency and limited bandwidth of satellite links, ensuring reliable and consistent voice service performance over the constrained NB-IoT access. Further, to meet key performance criteria, such as call setup time and experienced data rates, the embodiments described include enhancements to IMS functionality. These enhancements comprise optimizations to signaling and media handling that are specifically adapted to the operational constraints of NB-IoT over satellite connections. Further, the embodiments described provide support for IMS emergency calling over NB-IoT NTN via satellite, in accordance with the requirements defined in 3GPP TS 22.261 and TS 22.101. This includes functionality to enable emergency services in remote areas where terrestrial access is not available. The embodiments described also incorporate adaptations to existing location service mechanisms to ensure that accurate user equipment (UE)/wireless device location information is obtained and delivered during emergency sessions, thereby meeting regulatory compliance for emergency communication over satellite networks.

To enhance transmission efficiency over narrowband satellite links, at least some of the described embodiments include User Plane CIoT EPS Optimization with Non-IP Data Delivery (UP NIDD) for both signaling and voice media. NB-IoT channels operating over satellites face significant bandwidth constraints, limited to 180 kHz in in-band or guard-band modes and up to 200 kHz in standalone mode. Moreover, the number of simultaneous voice calls over a non-anchor carrier may be restricted to as few as 20. In this context, minimizing protocol overhead is essential to maximizing voice capacity, making UP NIDD a key enabler for throughput optimization. As illustrated in Table 1, UP NIDD provides a highly efficient communication protocol with minimal overhead, ideally suited for high-latency, bandwidth-limited environments such as GEO-based Non-Terrestrial Networks (NTN).

For an embodiment, an anchor carrier in wireless communication is the primary frequency band or component carrier used to establish the initial connection between a mobile device (UE) and a base station, especially in carrier aggregation (4G LTE/5G). It manages essential control signaling, synchronization, and initial paging, while additional, non-anchor carriers are added to increase data capacity. For an embodiment, a non-anchor carrier in wireless (specifically NB-IoT) is a secondary radio frequency carrier used for data transmission, but it lacks the synchronization signals and system information (SIB) required for initial network access.

TABLE 1
Data Delivery Overhead Comparisons

| Bytes | RTP | UDP | IP | PDCP | RRC | NAS | RLC | MAC | BSR | Total |
|---|---|---|---|---|---|---|---|---|---|---|
| IPv4 | 12 | 8 | 20 | 1 | | 3 | 2 | 1 | 2 | 49 |
| IP with RoHC | | | 1 | 1 | | 3 | 2 | 1 | 2 | 10 |
| UP NIDD | | | | 1 | | | 1 | 2 | 2 | 6 |
| CP NIDD | | | | | 2 | 11 | 2 | 2 | 2 | 19 |

In addition to the efficiency benefits, UP NIDD avoids a key limitation of Control Plane CIoT EPS Optimization, where AS-level security is not applied, as user data is carried over NAS signaling. In contrast, UP NIDD, operating over the user plane, enables the use of AS-level security mechanisms. This ensures the confidentiality and integrity of communications, providing a secure communication channel even in constrained environments.

Although NB-IoT does not support dedicated data radio bearers, UP NIDD utilizes the default bearer, which is configurable to optimize radio-level operations, such as RLC AM for signaling and RLC UM for media. This configuration enables improved reliability and effective latency management, further enhancing the performance of the system in challenging GEO satellite link conditions.

The use of Session Initiation Protocol (SIP) for IMS session setup over NB-IoT NTN GEO links, however, is not suitable due to several inherent limitations. SIP is characterized by high signaling overhead, typically ranging from 500 to 1,500 bytes per message, and requires multiple round-trip exchanges for session establishment (e.g., INVITE, 180 Ringing, 200 OK, ACK). Additionally, the lack of SIP stack support on many NB-IoT devices further complicates its use. These factors contribute to excessive signaling latency and increased communication burden, which are particularly problematic in high-latency satellite environments.

Considering these challenges, at least some of the embodiments described include the use of IMS Service Centralization and Continuity (SCC) architecture, as defined in Clause 4.20 of TS 23.228 and TS 23.292, for IMS session establishment over NB-IoT NTN GEO links. The I1 protocol, as outlined in 3GPP TS 24.294, is specifically designed for scenarios where the bearer path is constrained (e.g., CS or NIDD), but IMS service control is still required. The I1 protocol is a highly lightweight signaling protocol, with fixed header-length of 7 bytes, making it ideally suited for low-bandwidth, high-latency satellite links. Its use significantly reduces transmission time and overhead, facilitating efficient IMS session setup. Originally designed for CS-to-IMS interworking and IMS Centralized Services (ICS), the I1 protocol is easily adaptable to NIDD-to-IMS interworking, as described in Section 2.1. The I1 protocol is already standardized and supported by the SCC-AS, and its application eliminates the need for a SIP stack on the User Equipment (UE), simplifying device implementation and reducing complexity.

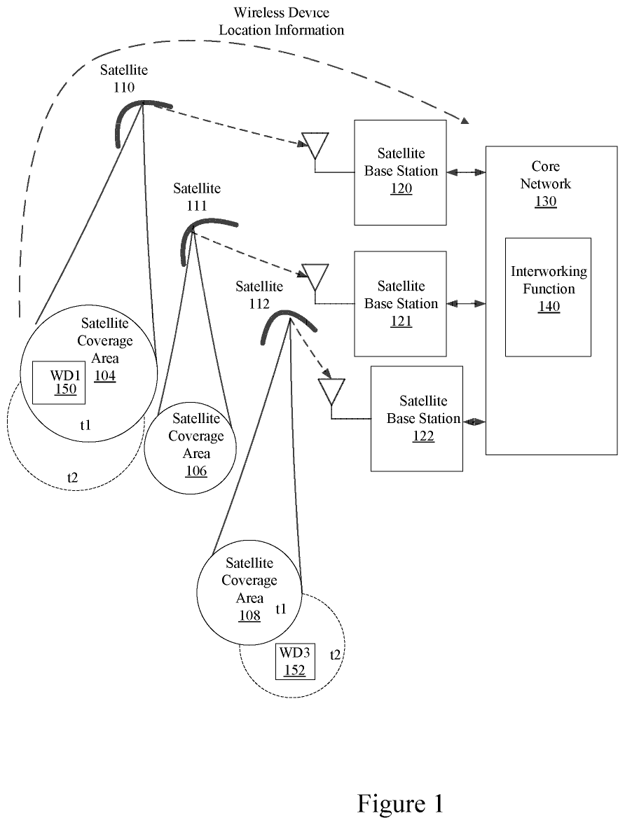

FIG. 1 shows a Narrowband Internet-of-things (NB-IoT) Satellite Non-Terrestrial Network (NTN) that includes a core network 130, base stations 120, 121, 122, and wireless devices 150, 152 communicating with the base stations 120, 121, 122 through satellite 110, 11, 112 according to an embodiment. As shown, the plurality of base stations 120, 121, 122 provide wireless satellite network coverage 104, 106, 108 through corresponding satellites 110, 111, 112. For an embodiment, one or more of the satellites 110, 111, 112 have coverage areas that are changing over time. For example, as shown, satellite coverage area 104 changes from time t1 to time t2. Further, for an embodiment, the wireless devices 150, 152 that may be connected to the wireless satellite network move as well.

For an embodiment, the base stations 120, 121, 122 are electronically connected to a core network 130 of the satellite network. For an embodiment, the core network 130 includes an interworking function (IWF) 140.

For an embodiment, the core network 130 is configured to establish for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device.

Further, for an embodiment, the wireless device 110 is configured to establish the two separate DRBs for an IMS voice session including the first DRB for transporting the signaling traffic and a second DRB for transporting the voice media packets, send, by a data transport of the wireless device, at least one of the signaling traffic or the voice media packets with non-IP packets, configure a radio link control (RLC) acknowledged mode for the signaling traffic and an unacknowledged mode for the voice media packets, and initiate, by a control module of the wireless device, an IMS session setup using signaling, wherein the signal includes messages to support call set up, release, modifications, and call registration, and wherein the signaling traffic includes data streams that include the messages.

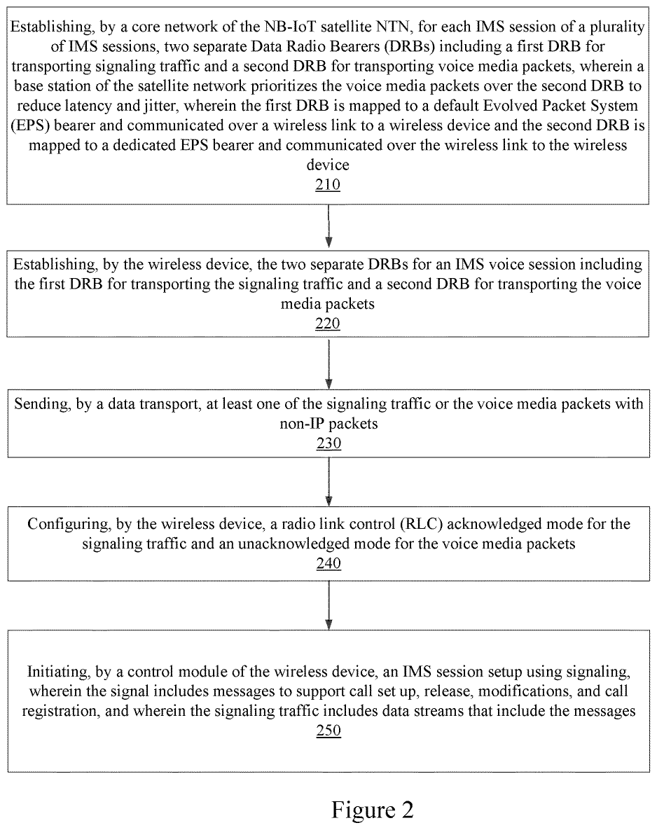

FIG. 2 is a flow chart that includes steps of a method of a Narrowband Internet-of-things (NB-IoT) Satellite Non-Terrestrial Network (NTN), according to an embodiment. A first step 210 includes establishing, by a core network of the NB-IoT satellite NTN, for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device. For at least some of the described embodiments, an “EPS bearer” or “End-to-end bearer” refers to a logical, end-to-end communication path established between a wireless device and an egress gateway of the core network of the NB-IoT satellite NTN. The bearer provides a specific QoS (Quality of Service) profile for routing user plane data across both a radio access network and the core network. For at least some embodiments, an ‘EPS bearer’ refers to a virtual connection that spans from a mobile communication device (wireless device) across a radio access network to an anchor gateway in the core network. For at least some embodiments, an ‘EPS bearer’ serves as the primary mechanism for establishing end-to-end QoS for user data payloads. An EPS bearer typically comprises a combination of a data radio bearer over an air interface and one or more core network transport bearers. For an embodiment, unlike the DRB (which stops at the cell tower/base station), the EPS Bearer stretches all the way from the wireless device to a gateway of the core network (the bridge to the external Internet). For an embodiment, a DRB data radio bearer) includes a logical or virtual communication channel established across a wireless air interface between a user device and a network node, specifically designated for the transportation of user plane data. This is distinguished from signaling radio bearers, which are utilized for control plane messages.

For an embodiment, the DRB maps user data packets to specific radio sources based on associated Quality of Service (QoS) parameters, facilitating the transfer of user data traffic. For an embodiment, the mapping of a Service Data Flow (SDF) to a specific EPS bearer is governed by a Traffic Flow Template (TFT) comprising one or more packet filters. In the uplink direction (for example, from the wireless device through a satellite to the base station), the wireless device evaluates an outgoing IP packet against an Uplink TFT. If a packet matches a specific filter within the TFT, the wireless device maps the packet to the dedicated EPS bearer associated with that TFT and transmits the packet over the air interface utilizing the corresponding 1:1 mapped Data Radio Bearer (DRB). For an embodiment, if no dedicated filter match occurs, the packet is mapped to the default EPS bearer and its associated DRB.

For an embodiment, to route user data, the NB-IoT satellite NTN utilizes a set of packet filters or routing rules. An incoming data flow (for example, a stream of IP packets) is evaluated against these packet filters based on header information, such as source/destination IP addresses or port numbers. Based on this evaluation, for an embodiment, the data flow is mapped to a specific logical bearer (such as a default or dedicated bearer) that satisfies the required Quality of Service (QoS) profile for that specific data flow. For an embodiment, the data is subsequently transmitted over the wireless interface using the data radio bearer associated with the selected logical bearer.

At least some of the described embodiment, include using two DRBs, one DRB for signaling, the other DRB for voice packets. In this way, for an embodiment, the signaling DRB can be mapped to a QoS to allow the radio interface to transfer this message based on the priority associated with QoS parameters. Similarly, for an embodiment, voice packets DRB can be mapped to the other QoS to allow the radio interface to transfer these data based on the priority associated with the QoS parameters associated with the data. For an embodiment, these QoS parameters are pre-defined in the core network by an IMS voice server over NB-IoT satellite NTN operators.

For an embodiment, a wireless device is configured to support IMS voice communication over the NB-IoT satellite NTN. A second step 220 includes establishing, by the wireless device, the two separate DRBs for an IMS voice session including the first DRB for transporting the signaling traffic and a second DRB for transporting the voice media packets.

While step 220 is directed to operation of the wireless device, it is to be understood that step 220 can additionally or alternatively be performed by other devices of the NB-IoT satellite NTN. Operations of the wireless device may be directed to uplink traffic from the wireless device to the base station. However, operations of other devices (such as wireless base stations, or core network nodes) may use these operations for downlink wireless communication involving DRB, and/or data transport.

A third step 230 includes sending, by a data transport of the wireless device, at least one of the signaling traffic or the voice media packets with non-IP packets. Specifically, this may include non-IP packets for voice and IP-packets for signaling, non-IP packets for signaling and IP packets for voice, or non-IP packets for voice and non-IP packets for signaling. For an embodiment, the data transport includes non-IP packet data transport. For an embodiment, the data transport includes removing IP/UDP header. For an embodiment, the data transport involves media data transport without an IP/UDP header. For example, the data transport may include an IP/UDP header removal mechanism.

At least some of the embodiments described provide substantial advantages in bandwidth-constrained environments. For example, for an embodiment, the data transport includes operations to remove the IP/UDP headers at a transmitting node (such as, the wireless devices or the base station) prior to transmission. The data is then transmitted as a payload over a wireless link, such as a satellite transmission link. Upon receipt at a receiving node (such as, the wireless devices or the base station) in the network, operations are performed to restore the IP/UDP headers to the payload. This header removal and restoration process significantly reduces the overhead of data transmission over the satellite transmission link.

For at least some of the described embodiments, the wireless device and/or the NB-IoT satellite NTN are configured to perform non-IP data transport. For an embodiment, the data transport involves direct non-IP data delivery (Direct NIDD). Upon receiving a non-IP data payload from the wireless network, for an embodiment, a core network of the NB-IoT satellite NTN egress node routes the non-IP data payload directly to an application server or destination node without encapsulating the payload within an intermediate internet protocol (IP) or tunneling header.

For at least some of the described embodiments, the NB-IoT satellite NTN utilizes direct routing for Non-IP Data Delivery (NIDD) over an egress interface. For an embodiment, a core network gateway of the NB-IoT satellite NTN, such as a Packet Data Network Gateway (PGW) or User Plane Function (UPF), receives the non-IP data payload associated with a specific Evolved Packet System (EPS) bearer or PDU session. The gateway is configured to forward the non-IP packet data payload directly to a Services Capability Server (SCS) or Application Server (AS) via an SGi or N6 interface using a direct routing configuration, thereby avoiding the overhead of Point-to-Point (PtP) IP tunneling.

As shown in table 1, these data transport embodiments help to make data transmission more efficient. Without these packet headers, these embodiments eliminate a significant amount of overhead so that the narrow-band satellite transmission link can focus on useful data and signaling transport. These packet headers can then be restored at the wireless device or network nodes of the NB-IoT satellite NTN locally, saving the overhead to transport those packet headers. As an analogy, this process is similar to iPhone® packaging, The packaging (like the ip/udp header of the described embodiments) deliver the iPhone itself (this is like the voice packets payload or signaling payload of the described embodiments) to a middle point (interworking function or a core network node, or a base station of the described embodiments), saving the space consumed by the protective packaging of the iPhone. The iPhone can be repackaged at the middle point (this is like the IWF function of the described embodiments) to deliver to the next stop (this is like the IMS network nodes, e.g. CSCF, of the described embodiments). There is no bottleneck (no bottleneck suggests a wider pipe than the satellite link between wireless device and base station over satellite transmission link) between the middle point and destination, which then operates, for example, as a fat pipe with fiber connection between the IWF and core network node of the NB-IoT satellite NTN.

A fourth step 240 includes configuring, by the wireless device, a radio link control (RLC) acknowledged mode for the signaling traffic and an unacknowledged mode for the voice media packets. For an embodiment, the RLC is a 3GPP Layer 2 protocol in mobile networks (LTE, 5G) located between the PDCP and MAC layers. For an embodiment, the Radio Link Control (RLC) ensures reliable data transmission by managing segmentation, reassembly, error correction via Automated Repeat Request (ARQ), and in-sequence delivery to higher layers, operating in Transparent (TM), Unacknowledged (UM), or Acknowledged (AM) modes. For an embodiment, the acknowledged mode includes data transmission that refers to a communication protocol configuration over a wireless link wherein the receiving node provides explicit feedback indicating the successful or unsuccessful reception of transmitted data packets. For an embodiment, the transmitting node is configured to retransmit any packets identified as lost or corrupted to ensure reliable, error-free delivery.

For an embodiment, the RLC Acknowledged Mode′ (AM) includes an operational mode of the Radio Link Control (RLC) layer characterized by the implementation of Automatic Repeat reQuest (ARQ) procedures. For an embodiment of RLC AM, the transmitting RLC entity ensures reliable, in-sequence delivery of Protocol Data Units (PDUs) by processing status reports received from the peer receiving RLC entity and retransmitting any missing or dropped PDUs.

For an embodiment, the unacknowledged mode data transmission includes a communication protocol configuration over a wireless link wherein data packets are transmitted without requiring reception feedback or status reports from the receiving node. For an embodiment, the transmitting node does not perform retransmissions of lost or dropped packets, thereby minimizing transmission overhead and prioritizing low-latency delivery over strict data reliability. For an embodiment, the unacknowledged mode includes an operational mode of the Radio Link Control (RLC) layer wherein Automatic Repeat reQuest (ARQ) procedures are disabled or not utilized. In RLC UM, the transmitting RLC entity forwards Protocol Data Units (PDUs) without requiring acknowledgment from the peer receiving RLC entity, making it suitable for delay-sensitive, error-tolerant traffic flows.

For an embodiment, IMS signaling or multimedia session signaling includes application-layer control messages exchanged between the wireless device and a subsystem of the NB-IoT satellite NTN to establish, modify, manage, and terminate IP-based multimedia communication sessions, such as voice or video calls. For an embodiment, the signaling utilizes protocols such as the Session Initiation Protocol (SIP) or I1 protocol to handle call setup, routing, and teardown, distinct from the transport of the actual multimedia user payload.

A fifth step 250 includes initiating, by a control module of the wireless device, an IMS session setup using signaling, wherein the signal includes messages to support call set up, release, modifications, and call registration, and wherein the signaling traffic includes data streams that include the messages.

For an embodiment, the Radio Link Control (RLC) includes a 3GPP Layer 2 protocol in mobile networks (LTE, 5G) located between Packet Data Convergence Protocol (PDCP) and MAC layers. For an embodiment, the RLC ensures reliable data transmission by managing segmentation, reassembly, error correction via Automated Repeat Request (ARQ), and in-sequence delivery to higher layers, operating in Transparent (TM), Unacknowledged (UM), or Acknowledged (AM) modes.

For an embodiment, an Evolved Packet System (EPS) bearer includes a logical, virtual tunnel with defined Quality of Service (QoS) parameters transporting user IP traffic between User Equipment (UE) and the Packet Data Network Gateway (PGW) in 4G LTE networks.

The described embodiments provide voice service over NB-IoT NTN access which is not currently possible. For an embodiment, the combination of NB-IoT NTN and the user plane for signaling (particularly binary encoded signaling e.g. I1) and voice packet data both on the user plane have not been previously implemented. To fit the voice packets in the user plane of NB-IoT NTN, at least some of the described embodiments use non-IP data to reduce header overhead, and binary-encoded signaling.

The user plane (data plane) over a satellite network handles the actual transmission of user traffic, such as internet browsing and file transfers, by acting as a high-speed data path between the user equipment and the core network. In modern 5G satellite architectures, this involves packet forwarding, traffic encapsulation (GTP-U), and Quality of Service (QoS) enforcement via a User Plane Function (UPF) to manage data flow, even with high-latency links.

For an alternate embodiment, the first and second DRBs are at least one of 1) carried over a shared default Evolved Packet System (EPS) bearer, 2) carried over two separate default EPS bearers, or 3) the first DRB is mapped to and communicated over a wireless link to a wireless device over a default Evolved Packet System (EPS) bearer and the second DRB is mapped to and communicated over the wireless link to the wireless device over a dedicated EPS bearer. For an embodiment, the selection between 1, 2, or 3 is selected by a network operator. For an embodiment, not all of them can be selected at the same time.

For an embodiment, a DRB is a data path or radio bearer that is used only for the transmission of user plane data. For an embodiment, the DRB is a user data path between a wireless device (UE) and a base station (eNB). For an embodiment, when the DRB is mapped to an S1 Bearer to carry user traffic, the combined path is called an E-RAB (E-UTRAN Radio Access Bearer. For an embodiment, the DRB is specifically a radio-leg portion of an end-to-end user data pipe. For an embodiment, an EPS Bearer is a virtual “pipe” that connects a wireless device/UE all the way to a Gateway (P-GW) that leads to the Internet. For an embodiment, an EPS bearer is a concatenation of DRB (between the wireless device and the base station), S1 Bearer (between eNB and SGW), and S5/S8 Bearer (between S-GW and P-GW).

An embodiment includes transporting (wirelessly communicating over wireless links between a wireless device and a base station through a satellite) voice media packets over the second DRB with preferential handling to address latency and jitter sensitivity. More precisely, compared to a default bearer, which typically provides “best-effort” handling and employs retransmission protocols (like RLC Acknowledged Mode) that introduce variable delay to ensure error-free delivery suitable for general data; the second DRB on dedicated bearer is configured with parameters (such as QCI with higher priority to be treated in a queue, specific delay budgets, and/or Radio Link Control (RLC) Unacknowledged Mode) that optimize for speed.

For an embodiment, the data transport uses an RLC acknowledged mode (AM) for signaling and RLC unacknowledged mode (UM) for the voice media packets. For an embodiment, the RLC Acknowledged Mode (AM) includes a 4G/5G data transfer mode ensuring reliable, error-free, in-sequence delivery of packets (SDUs) using Automatic Repeat Request (ARQ). For an embodiment, the Radio Link Control Unacknowledged Mode (RLC-UM) includes a 4G/5G data transfer mode providing segmentation, concatenation, and reordering without retransmission, ideal for delay-sensitive traffic like VoIP or streaming.

A least some embodiments further include utilizing, by the core network of the NB-IoT satellite NTN, an interworking function (IWF) to translate the signaling and the voice media packets for communication with standard IMS network components, wherein the interworking function performs codec resolution by extracting codec information from I1 and/or SIP signaling and performing local transcoding, thereby eliminating end-to-end codec negotiation. For an embodiment, performing local means performing on the wireless device. For an embodiment, transcoding eliminates codec negotiation. For example, in the case of voice packet over a GEO (Geostationary Earth Orbit) satellite network, if the NB-IoT NTN knows the wireless device is going to use a low bit rate codec based on historical data, it will not negotiate and transcode to the IMS codec directly without negotiation.

For an embodiment, the NB-IoT NTN includes an interworking function (IWF) configured to streamline session establishment. Rather than relying on traditional end-to-end codec negotiation between a transmitting device and a receiving device, which requires multiple round-trip signaling exchanges, for an embodiment, the interworking function performs local codec resolution. Specifically, the IWF extracts necessary codec information directly from incoming session signaling, such as I1 and/or SIP signaling messages. Based on this extracted information, local transcoding is performed. For an embodiment, by intercepting the signaling and performing transcoding locally at the IWF, the requirement for end-to-end codec negotiation is eliminated, thereby significantly reducing call setup latency and conserving signaling bandwidth. For an embodiment, the transcoding can eliminate codec negotiation. For example, in the case of voice over GEO (Geostationary Earth Orbit), if the NB-IoT NTN knows the wireless device is going to use a low bit-rate codec based on historical data, it will not negotiation and transcode to the IMS codec directly without negotiation.

For an embodiment, Session Initiation Protocol (SIP) includes a text-based, application-layer signaling protocol designed to initiate, maintain, modify, and terminate real-time communication sessions over IP networks, such as voice and video calls. However, at least some of the described embodiments alternatively utilized binary-encoded I1 signaling. For at least some embodiment, I1 includes an LTE Cat 1 (Category 1) which includes a 4G cellular standard designed for IoT and M2M applications requiring medium data speeds (10 Mbps downlink/5 Mbps uplink), low power, and full mobility.

At least some embodiments further include utilizing, by the core network of the NB-IoT satellite NTN, an interworking function (IWF) to translate the signaling and the voice media packets for communication with standard IMS network components, wherein the interworking function is deployed as a network function or an application server, e.g. within a Session Border Controller (SBC) and implements a back-to-back user agent (B2BUA) to map I1 messages to SIP as specified in 3GPP TS 23.228. For an embodiment, includes SBC a network security device that manages, secures, and regulates real-time IP communication sessions (voice, video, messaging) at the edge of the NB-IoT NTN. For an embodiment, the Back-to-Back User Agent (B2BUA) is a Session Initiation Protocol (SIP) network element that acts as both a recipient (Server) and creator (Client) of SIP requests, bridging two distinct call legs in a communication session of the NB-IoT NTN.

For an embodiment, the wireless device relies on signaling and voice DRBs to make voice calls over the satellite deployed as LEO, MEO, and/or GEO. Low Earth Orbit (LEO) satellites operate between 160 and 2,000 km above Earth, providing high-speed, low-latency internet, earth observation, and communication services. Medium Earth Orbit (MEO) satellites operate within an altitude range of 2,000 to 35,786 kilometers (about 1,200 to 22,236 miles) above the Earth. Geostationary Earth Orbit (GEO) satellites operate at approximately 35,786 km above the equator, matching Earth's rotation to remain fixed over one spot.

For an embodiment, the DRBs are established over NB-IoT using standalone, in-band, or guard-band configurations with a specified bandwidth, and with one anchor channel (meaning channel with synchronization signals and control signals such as NPSS ((Narrowband Primary Synchronization Signal)), NSSS ((Narrowband Primary Synchronization Signal)), NPBCH ((Narrowband Physical Broadcast Channel)), NPDCCH ((Narrowband Physical Downlink Control Channel)), NPDSCH signals), and/or one or more non-anchor channels as specified in TS 36.331. For the described embodiments, the NPSS (Narrowband Primary Synchronization Signal) includes a physical layer signal used by a device to perform initial time and frequency synchronization with an NB-IoT cell, the NSSS (Narrowband Secondary Synchronization Signal) includes physical layer signal used by a device to acquire the cell identity and frame timing of an NB-IoT cell, the NPBCH (Narrowband Physical Broadcast Channel) includes physical channel that carries essential system information (the Master Information Block) required for a device to access the network, and the NPDCCH (Narrowband Physical Downlink Control Channel): A physical channel used to carry downlink control information, including scheduling assignments for data reception and transmission.

At least some embodiments further include providing Quality of Service (QoS) differentiation for IP Multimedia Subsystem (IMS) voice services over the NB-IoT NTN, including establishing a default data bearer between the wireless device and a Packet Gateway (PGW) over an NB-IoT radio access network (RAN), associating a predefined Quality of Service Class Identifier (QCI) value with the bearer for prioritization of IMS voice traffic, applying a QoS policy at the RAN based on an association with the predefined QCI value to enable differentiated handling of IMS voice traffic relative to other data traffic, and forwarding IMS voice packets with a predefined QCI value over the default data bearer to enable low-latency and high-priority transmission. For an embodiment, the predefined QCI value assigned for IMS voice traffic is selected to provide low-latency and high-priority handling (such as QCI 85) though other standardized or operator-defined QCI values suitable for IMS voice. For an embodiment, a QoS policy includes applying scheduling prioritization for IMS voice traffic at the base station based on the predefined QCI value. At least some embodiments further include configuring the default data bearer to carry only IMS voice traffic and enabling Guaranteed Bit Rate (GBR) enforcement for the associated voice media.

At least some embodiments further include providing QoS differentiation for IMS voice services over NB-IoT, including provisioning a dedicated Access Point Name (APN) for IMS voice services, detecting a Packet Data Network (PDN) connection request from the wireless device to the dedicated APN for IMS voice services, applying Differentiated Services Code Point (DSCP) markings to outbound IP packets from a Packet Gateway (PGW), wherein IMS voice media packets are marked with a high-priority DSCP value, establishing a default data bearer for the wireless device over an NB-IoT wireless link, and interpreting the DSCP markings at a RAN (NB-IoT radio access network) to apply differentiated treatment for the IMS voice traffic, including prioritization in radio scheduling. At least some embodiments further include applying internal configuration flags or custom Information Elements (IEs) in signaling messages to instruct the base station to prioritize IMS voice traffic based on the detected service type. For an embodiment, the base station classifies DSCP-marked packets into radio scheduling queues, placing IMS voice packets into a high-priority queue and non-IMS packets into a lower-priority queue. For an embodiment, no QCI value is introduced, and QoS differentiation is achieved solely through DSCP markings and service-type awareness. It is to be understood that in conventional cellular network architectures, Quality of Service (QoS) is strictly governed by the assignment of a QoS Class Identifier (QCI), which necessitates the establishment of specific bearers and associated control plane signaling. In contrast, an embodiment of the present invention completely bypasses this requirement, introducing no QCI values during data transport. Instead, QoS differentiation is achieved in a stateless or signaling-free manner using Differentiated Services Code Point (DSCP) markings embedded within the packet headers. Network nodes along the transmission path evaluate these DSCP markings to determine the localized per-hop behavior and priority of the packets. Additionally, QoS differentiation may be augmented or achieved solely through service-type awareness, wherein the network or device dynamically determines the required handling priority based on the intrinsic characteristics of the payload or the application generating the traffic flow.

To reduce or minimize control plane overhead, particularly in bandwidth-constrained or high-latency environments such as satellite transmission links, at least some of the described embodiments utilize a simplified QoS enforcement architecture. Specifically, at least some of the embodiments described eliminate the utilization of Evolved Packet System (EPS) bearer-level QCI parameters. For at least some of the described embodiments, traffic prioritization is instead pushed to the network layer via standard DSCP markings. To handle scenarios involving non-IP data transport or header removal (where DSCP markings may be unavailable over the air interface), the NB-IoT NTN utilizes service-type awareness logic. For an embodiment, this logic may comprise a Traffic Detection Function (TDF) or deep packet inspection (DPI) to identify the specific service type (e.g., voice media, IMS signaling, or best-effort data) directly from the application data stream, thereby applying the correct priority queueing without requiring explicit bearer QoS signaling. For an embodiment, the QoS mapping is then applied to internal configuration flags or custom Information Elements (IEs) in signaling messages to instruct the base station to prioritize IMS voice traffic based on the detected service type.

At least some embodiments further include enabling downlink QoS prioritization of IMS voice services over an NB-IoT wireless link, including establishing a default data bearer between wireless device and a Packet Gateway (PGW) over the NB-IoT satellite NTN, marking outbound IP packets for IMS voice services with a Differentiated Services Code Point (DSCP) values indicative of high-priority, latency-sensitive traffic, transmitting the DSCP-marked IP packets over the default data bearer to the base station, inspecting the DSCP values at the base station to classify incoming packets into scheduling queues based on a DSCP-to-priority mapping policy, and scheduling and transmitting the packets to the wireless device, wherein IMS voice packets are assigned to a high-priority transmission queue. For an embodiment, the DSCP value for IMS voice packets is set to Expedited Forwarding (EF) and the DSCP value for IMS signaling packets is set to Assured Forwarding (AF). For an embodiment, the base station assigns IMS voice packets marked with DSCP EF to a latency-optimized scheduling queue for reduced transmission delay. At least some embodiments further include applying Medium Access Control (MAC) and Radio Link Control (RLC) parameters, including scheduling class settings, based on the DSCP classification to enhance priority handling of IMS voice traffic.

At least some embodiments further include discovering codec capabilities of endpoints in an IP Multimedia Subsystem (IMS) or Session Initiation Protocol (SIP) network of the NB-IoT satellite NTN, including receiving a SIP REGISTER message from a registering wireless device registering with an IMS network; (wherein the IMS network is at the application layer at the core network of the NB-IoT NTN access to support call session control), inspecting one or more SIP headers included in the SIP REGISTER message, the headers comprising at least one of a User-Agent header, device-type identifier, or vendor-specific extension, mapping the inspected one or more SIP headers to a known device profile associated with codec capability information, determining codec capabilities of the registering wireless device based on the mapped device profile, and using the determined codec capabilities to select a codec for use in a call between the UE and a remote endpoint. For at least some embodiments, an IMS network or IP Multimedia Subsystem network includes an architectural framework operating at the application layer, situated within or communicatively coupled to the core network. In the context of the described NB-IoT Non-Terrestrial Network (NTN) access, the IMS network provides centralized call session control and routing to support multimedia communications, such as evaluating SIP REGISTER messages and establishing sessions over the satellite transmission link.

For an embodiment, the IMS network includes an application-layer subsystem associated with the core network that supports IP-based multimedia services and call session control. Unlike traditional terrestrial broadband access, the present embodiments interface the IMS network through an NB-IoT satellite NTN access. Consequently, the IMS network acts as the application-layer intelligence for session management (e.g., processing SIP REGISTER messages and managing user profiles) while relying on the underlying, optimized, signaling-reduced transport mechanisms (such as non-IP transport or header removal) to communicate with the registering wireless device.

For an embodiment, the mapping is performed using a codec profile database, the database storing predefined codec capability profiles corresponding to known device types. For an embodiment, a device type is defined or includes a device that supports IMS voice for NB-IoT NTN access. For an embodiment, the NB-IoT NTN is configured to utilize a codec profile database to perform local codec resolution without requiring end-to-end negotiation. For an embodiment, the database stores predefined codec capability profiles that are mapped to specific, known device types. By identifying the device type of an incoming connection request, the system can retrieve the corresponding codec profile to determine the supported media formats. Examples of device types may include classifications based on 3GPP standards, such as Category NB1 (Cat-NB1) or Category NB2 (Cat-NB2) devices, or specifically designated Non-Terrestrial Network User Equipment (NTN UE) classes. Furthermore, device types may be categorized based on their network provisioning capabilities, such as devices provisioned for IMS voice over NB-IoT NTN access, versus devices provisioned exclusively for non-voice signaling or Short Message Service (SMS) data. Additionally, device types may correspond to specific form factors or use cases deployed within the satellite coverage area, including but not limited to: emergency or SOS beacons requiring highly reliable low-bitrate voice codecs; maritime or asset tracking modules; wearable communication devices; and remote industrial sensors configured for exception-based audio or data reporting. At least some embodiments include identifying the known device type is achieved by extracting a device identifier from the signaling messages (e.g., from a SIP REGISTER message or initial network attachment signaling) and querying the codec profile database using the extracted identifier. The device identifier may comprise an International Mobile Equipment Identity (IMEI), an IMEI Software Version (IMEI-SV), a Permanent Equipment Identifier (PEI), a Media Access Control (MAC) address, or any other unique hardware or logical identifier associated with the endpoint. For an embodiment, the NB-IoT NTN is configured to parse the wireless device identifier to determine the specific commercial make and model of the wireless device. For example, the network may extract the Type Allocation Code (TAC) from the device's IMEI. Because the TAC uniquely corresponds to a specific manufacturer and model (e.g., a specific iteration of a smartphone manufactured by Apple Inc. or Samsung Electronics), the codec profile database can map the TAC directly to a predefined list of audio and video codecs hardcoded into that specific device model by the manufacturer. This allows the NB-IoT NTN to know with absolute certainty that a wireless device supports a specific codec (e.g., AMR-WB or EVS) without requiring the device to explicitly declare its capabilities in an SDP offer.

At least some embodiments further include transmitting, by the wireless device, a SIP OPTIONS request to a remote endpoint (end point that the wireless device is communicating with), receiving, by the wireless device, a SIP OPTIONS response including a Session Description Protocol (SDP) body identifying one or more codecs supported by the remote endpoint, and selecting, by the wireless device, a codec for use in a subsequent call based on the supported codecs listed in the SDP body. For an embodiment, the ‘SIP OPTIONS’ message refers to an application-layer signaling request utilized to query the capabilities, supported methods, and operational status of a target endpoint or network node prior to, or independently of, establishing a communication session. For an embodiment, in an IP Multimedia Subsystem (IMS) architecture, a ‘SIP OPTIONS’ request is a signaling method defined by the Session Initiation Protocol used to discover the capabilities of a User Agent (UA) or proxy server. The response to a SIP OPTIONS message typically includes a Session Description Protocol (SDP) body detailing the media types, audio/video codecs, and SIP extensions supported by the queried endpoint. For an embodiment, the SIP OPTIONS request is transmitted prior to initiation of a SIP INVITE message, thereby allowing codec determination prior to session establishment.

At least some embodiments further include determining codec capabilities of the wireless device using static device profiles, including storing, by the core network, a plurality of static device profiles in a codec capability database, each profile including a list of supported codecs for a corresponding device type, identifying, by the core network, a device type of the UE from a SIP REGISTER or SIP INVITE message, matching, by the core network, the identified device type to a corresponding static device profile, and selecting, by the core network, a codec for use in a session involving the wireless device based on the matched device profile. For an embodiment, the static device profiles are provisioned and updated based on device type, manufacturer information, or subscription data, and are maintained as part of a device management function.

At least some embodiments further include inferring codec capabilities of an endpoint based on historical data, including maintaining, by the core network, a cache of codec usage history for one or more endpoints, identifying, by the core network a previously used codec for a given endpoint from the history cache, and selecting, by the core network the previously used codec as a preferred codec for a new call involving the same endpoint. At least some embodiments further include updating the codec usage history cache upon completion of each call and retaining cached data for a configurable duration or number of past sessions.

At least some embodiments further include determining codec capabilities of endpoints in the NB-IoT satellite NTN, including inspecting, by a SIP Back-to-Back User Agent (B2BUA) Interworking Function (IWF) of the core network, SIP REGISTER messages, SIP OPTIONS messages, or previously stored device profiles, storing, by a database of the core network, static device profiles and/or codec usage history for multiple endpoints, determining, by a codec selection module of the core network, codec capabilities from inspected SIP headers, SIP OPTIONS responses, or stored profiles, and initiating or managing, by a communication interface of the core network, a call between endpoints using a codec selected by the codec selection module. For an embodiment, the codec selection module is further configured to prioritize dynamic codec discovery using SIP OPTIONS requests and to store results for reuse in subsequent calls.

At least some embodiments further include minimizing codec negotiation delays, including sending, by the wireless device, a SIP OPTIONS request to a target endpoint of the core network, the base station, a core network node, or an IWF node of the core network, receiving, by another wireless device, the core network node, or the IWF node of the core network, a SIP OPTIONS response including an SDP body that identifies supported codecs back from the target endpoint of the core network, storing, by the wireless device, the core network node, or the IWF node of the core network, the identified codec list in a local cache, and retrieving, by another wireless device, the core network node, or the IWF node of the core network, the cached codec list for future session setups with the same endpoint, thereby reducing the need for repeated codec negotiation. For an embodiment, the cached codec list is retained for a predefined time interval or until a detected update to the endpoint's capabilities triggers invalidation or refresh of the stored data.

At least some embodiments further include enhancing Real-Time Transport Protocol (RTP) packet transmission over a wireless interface between the wireless device and the base station, including receiving, at the base station, a core network node, or an interworking function of the core network, a reduced RTP packet from the wireless device, wherein the reduced RTP packet omits at least one original RTP header field, generating, by the base station, the core network node, or the interworking function of the core network, one or more information elements (IEs) comprising supplementary metadata associated with the reduced RTP packet, and prepending the base station, the core network node, or the interworking function of the core network, the one or more information elements to the reduced RTP packet to form an enhanced RTP packet for downstream processing or delivery. At least some embodiments further include detecting, at the base station, the core network node or interworking function node of the core network, an absence of attached information elements, and in response, generating and prepending a dummy information element as a placeholder to maintain structural integrity. For an embodiment, the information elements (IEs) are prepended in an arbitrary order and are byte-aligned for parsing efficiency. For an embodiment, the enhanced RTP packet is transmitted to a downstream network function, wherein the network function utilizes the prepended information elements for at least one of jitter compensation, quality assessment, or media stream synchronization. For an embodiment, the reduced RTP packet is generated at the user equipment by removing one or more RTP header fields, including at least a timestamp field, prior to transmission over a constrained wireless link.

For an embodiment, each of the one or more information elements includes an IE header including an extension (E) bit indicating whether additional information elements follow a comprehension (C) bit indicating whether the information element is mandatory for correct decoding, an information element (IE) type field identifying the semantic category of the information element, a reserved field for future extensions, and a length field specifying the length of the IE body in octets. For an embodiment, each information element further comprises an IE body, a content of which is determined based on a corresponding IE type field. For an embodiment, information element (IE) includes a discrete, structured data field, parameter, or data block embedded within a larger communication or signaling message. An information element acts as a modular container utilized to convey a specific piece of control, configuration, or management information between a transmitting node and a receiving node. In the context of 3GPP, an information element refers to a standardized data structure utilized within signaling protocol messages, such as Radio Resource Control (RRC) or Non-Access Stratum (NAS) messages. Each IE encapsulates specific network parameters, capabilities, or state information required for protocol operation, allowing for extensible and modular message construction. For an embodiment, an information element header refers to the initial segment or metadata portion of an information element. The header provides parsing instructions to the receiving node, typically comprising an identifier (such as an IE type field) that indicates the classification or purpose of the information element, and optionally a length field indicating the size of the subsequent information element body. In the context of 3GPP, an ‘information element header’ refers to the leading bits or bytes of an information element utilized to facilitate Type-Length-Value (TLV) or Type-Value (TV) encoding. The header comprises an Information Element Identifier (IEI) or ‘IE type field’ which dictates how the protocol stack of the receiving entity should decode and interpret the payload encapsulated within the corresponding ‘IE body’. For an embodiment, at least one of the information elements includes a timestamp information element, the timestamp encoded as a 64-bit Unix epoch value in network byte order.

At least some embodiments further include enhancing RTP packet delivery, including generating and transmitting, by the wireless device, reduced RTP packets over a wireless interface between the wireless device and the base station, wherein the wireless interface refers to a communication link or radio path between a wireless device (for example, a User Equipment or UE) and a network access node (for example, a base station, eNB, or gNB), receiving, by the base station, a core network node, or an interworking function of the core network, the reduced RTP packets, generating, by the base station, the core network node, or the interworking function of the core network, one or more information elements comprising metadata associated with the original RTP structure, and prepending, by the base station, the core network node, or the interworking function of the core network, the one or more information elements to the reduced RTP packet to produce an enhanced RTP packet. At least some embodiments include parsing, by the base station, the core network node, or the interworking function node of the core network, the prepended information elements and utilizing the metadata for calculating jitter, reconstructing timestamps, or improving media playback quality. As described, at least some of the embodiments include core network nodes. At least some embodiments include putting the IWF in the P-CSCF of the IMS network, wherein P-CSCF is an existing network function in IMS. For an embodiment, the P-CSCF functionality is expanded to support interworking between I1 signaling and standard SIP signaling. Similarly, for voice packets, for an embodiment, the existing AGW function is expanded to support the IWF to support transcoding, media format conversion etc.

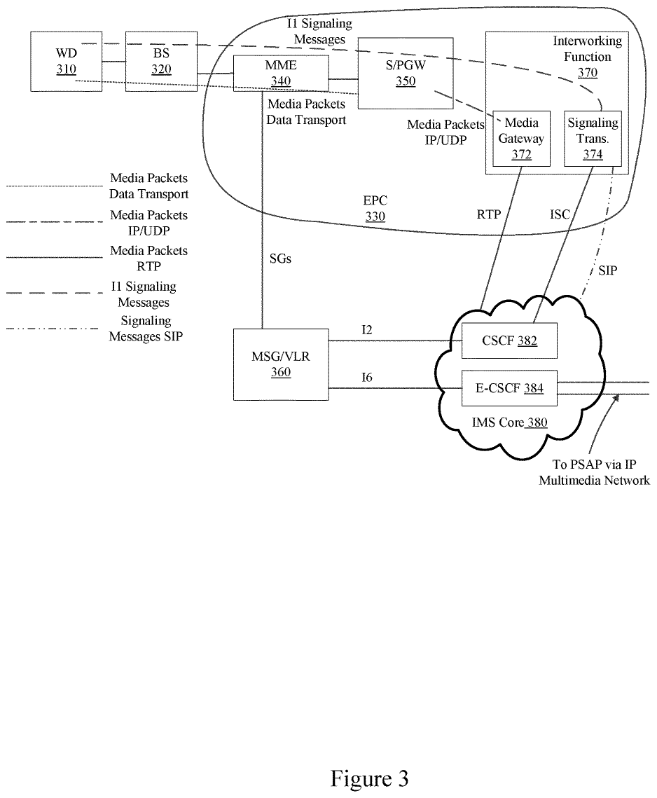

FIG. 3 shows an NB-IoT NTN) that supports IMS voice calls, according to another embodiment. As shown, a wireless device 310 wirelessly interfaces with a base station 320 through wireless links through a satellite. For at least some embodiments, the system architecture for supporting IP Multimedia Subsystem (IMS) voice services over a Narrowband Internet-of-things (NB-IoT) satellite Non-Terrestrial Network (NTN), as depicted in FIG. 3, operates by bifurcating communication into specialized signaling and media paths to mitigate the technical constraints of high-latency satellite links. The Wireless Device (WD) 310 wirelessly interfaces with the Base Station (BS) 320 via wireless links through a satellite and initiates a session by transmitting I1 signaling messages. For an embodiment, this signaling is communicated across the Base Station (BS) 320 to the Evolved Packet Core (EPC) 330, wherein a Mobility Management Entity (MME) 340 coordinates with an MSC/VLR 360 over an SGs interface to manage subscriber registration and mobility.

For an embodiment, the I1 signaling messages are received by an Interworking Function (IWF) 370, specifically a Service Centralization and Continuity Application Server (SCC-AS) or a Signaling Translation 374 function, which operates as a Back-to-Back User Agent (B2BUA) to translate binary I1 messages into standard Session Initiation Protocol (SIP) for the IMS Core 380.

For an embodiment, simultaneously, voice traffic is handled via Media Packets Data Transport utilizing a second, prioritized Data Radio Bearer (DRB), wherein media flows from the Wireless Device 310 to the Serving/Packet Data Network Gateway (S/PGW) 350 as non-IP data transport, Non-IP Data Delivery (NIDD), or voice data packets payload with IP/UDP header removed. This media is subsequently converted to standard IP/UDP and Real-Time Transport Protocol (RTP) by a Media Gateway 372 within the IWF 370. The processed media and signaling messages are delivered to the IMS Core 380, which comprises a Call Session Control Function (CSCF) 382 and an Emergency-Call Session Control Function (E-CSCF) 384.

For an embodiment, the Mobile Switching Center/Visitor Location Register (MSC/VLR) 360 is a functional network entity enhanced for IMS Centralized Services (ICS) that manages subscriber registration and authentication. For an embodiment, the MSC/VLR 360 utilizes an I2 interface to communicate with the CSCF 382 to perform IMS registration on behalf of the device, ensuring it is logically anchored in the IMS domain. For an embodiment, the CSCF 382 serves as a central signaling node within the IMS architecture, located in either a Visited Public Land Mobile Network (VPLMN) or a Home Public Land Mobile Network (HPLMN), and is responsible for handling SIP registration and routing. For an embodiment, the CSCF 382 functions as the primary point of contact for session management, ensuring that multimedia requests are directed between endpoints or application servers. For at least some of embodiments of the described NB-IoT NTN architecture, the CSCF 382 receives translated signaling from the IWF 370 to facilitate seamless call integration between constrained satellite links and standard IP networks. For an embodiment, the E-CSCF 384 is a specialized functional entity designated to handle and route emergency service requests—whether from a registered device or an anonymous caller—to the appropriate Public Safety Answering Point (PSAP) based on location information. For an embodiment, the E-CSCF 384 interfaces with the MSC/VLR 360 via an I6 interface to ensure regulatory compliance for emergency communications over non-terrestrial networks.

For an embodiment, the wireless device (User Equipment (UE)) 310 that initiates or receives voice sessions. For an embodiment, the wireless device 310 is configured to handle I1 signaling and Media Packets Data Transport. For an embodiment, the Base Station (eNB) 320 is an access node that interfaces with the wireless device 310 via a satellite link, managing the radio legs of the communication. For an embodiment, the core network (EPC (Evolved Packet Core)) 330 includes the MME for mobility management and the S/PGW for user plane anchoring. For an embodiment, the Interworking Function (IWF) 370 is a critical translation layer that includes the Media Gateway (MGW) 372 that translates media between optimized data transport and standard RTP, the SCC-AS (Service Centralization and Continuity Application Server) which acts as a Back-to-Back User Agent (B2BUA) to anchor sessions and translate signaling, and the MSC/VLR 360 which is enhanced for IMS Centralized Services (ICS) to manage registration and location updates via the SGs interface. For an embodiment, the IMS Core 380 includes the application layer providing call control through the CSCF 382 and emergency session handling via the E-CSCF 384.

Support of IMS Service Centralization is specified in TS 23.228 and TS 23.292. IMS service centralization provides communication services such that all services, and service control, are based on IMS mechanisms and enablers. It enables IMS services. Originally, this architecture supported CS access as bearer for the media. At least some of the described embodiments further expand the architecture to support IMS services when using NB-IoT NTN access as bearer for the media, as shown in FIG. 3.

The I1 protocol enables sessions that originate from or terminate in the NIDD domain to be anchored and controlled by IMS. This ensures service centralization and consistent behavior across both NIDD and packet-switched IMS domains.

For an embodiment, when a user (wireless device 110) with NB-IoT NTN accesses and an IMS subscription initiates or receives a voice call via GEO satellite, the session falls back to a User Plane (UP) NIDD-based configuration. For an embodiment, two DRBs are established per IMS session, one for I1 signaling and one for voice media. This separation allows media traffic to receive differentiated treatment, even in the absence of conventional QoS mechanisms. Further, for an embodiment, an interworking function (IWF) receives session signaling over the I1 protocol. Further, for an embodiment, the IWF performs I1-to-SIP and SIP to I1 message translation, allowing seamless integration with standard IMS components. Further, for an embodiment, codec information included in the I1 message enables the IWF to determine whether transcoding is required. By resolving codec mismatches internally, the system avoids traditional end-to-end codec negotiation, significantly reducing call setup latency, especially important in high-delay satellite environments.

For an embodiment, the NIDD UP session is anchored at the Service Centralization and Continuity Application Server (SCC AS), which maintains IMS session control and service logic regardless of the underlying access technology.

For an embodiment, all external interfaces of the interworking function comply with existing 3GPP specifications, so no additional standardization is required. Since the interworking function operates entirely within the operator's network domain, the interworking function can be deployed without impacting standardized interfaces. In practice, the interworking function can be integrated into the SBC, with the I1-to-SIP mapping implemented as a B2BUA, effectively providing a SIP trunk between the interworking function and the IMS core.

For an embodiment, for transport, the User Plane NIDD uses RLC Acknowledged Mode (AM) for DRB carrying the signaling message to ensure reliable delivery, and RLC Unacknowledged Mode (UM) for DRB carrying the media packets to reduce latency. Both bearers can be configured by the base station as needed.

For an embodiment, because codec negotiation is handled entirely by the interworking function, there is no need for direct capability exchange between endpoints. This simplifies design of the wireless device and enables a seamless, efficient voice experience across diverse networks and device types.

### QoS Support

As previously described, at least some embodiments further include providing Quality of Service (QoS) differentiation for IP Multimedia Subsystem (IMS) voice services over the NB-IoT NTN, including establishing a default data bearer between the wireless device and a Packet Gateway (PGW) over an NB-IoT radio access network (RAN), associating a predefined Quality of Service Class Identifier (QCI) value with the bearer for prioritization of IMS voice traffic, applying a QoS policy at the RAN based on an association with the predefined QCI value to enable differentiated handling of IMS voice traffic relative to other data traffic, and forwarding IMS voice packets with a predefined QCI value over the default data bearer to enable low-latency and high-priority transmission. For an embodiment, the predefined QCI value assigned for IMS voice traffic is selected to provide low-latency and high-priority handling (such as QCI 85) though other standardized or operator-defined QCI values suitable for IMS voice. For an embodiment, a QoS policy includes applying scheduling prioritization for IMS voice traffic at the base station based on the predefined QCI value. At least some embodiments further include configuring the default data bearer to carry only IMS voice traffic and enabling Guaranteed Bit Rate (GBR) enforcement for the associated voice media.

As previously described, at least some embodiments further include providing QoS differentiation for IMS voice services over NB-IoT, including provisioning a dedicated Access Point Name (APN) for IMS voice services, detecting a Packet Data Network (PDN) connection request from the wireless device to the dedicated APN for IMS voice services, applying Differentiated Services Code Point (DSCP) markings to outbound IP packets from a Packet Gateway (PGW), wherein IMS voice media packets are marked with a high-priority DSCP value, establishing a default data bearer for the wireless device over an NB-IoT wireless link, and interpreting the DSCP markings at a RAN (NB-IoT radio access network) to apply differentiated treatment for the IMS voice traffic, including prioritization in radio scheduling. At least some embodiments further include applying internal configuration flags or custom Information Elements (IEs) in signaling messages to instruct the base station to prioritize IMS voice traffic based on the detected service type. For an embodiment, the base station classifies DSCP-marked packets into radio scheduling queues, placing IMS voice packets into a high-priority queue and non-IMS packets into a lower-priority queue. For an embodiment, no QCI value is introduced, and QoS differentiation is achieved solely through DSCP markings and service-type awareness. It is to be understood that in conventional cellular network architectures, Quality of Service (QoS) is strictly governed by the assignment of a QoS Class Identifier (QCI), which necessitates the establishment of specific bearers and associated control plane signaling. In contrast, an embodiment of the present invention completely bypasses this requirement, introducing no QCI values during data transport. Instead, QoS differentiation is achieved in a stateless or signaling-free manner using Differentiated Services Code Point (DSCP) markings embedded within the packet headers. Network nodes along the transmission path evaluate these DSCP markings to determine the localized per-hop behavior and priority of the packets. Additionally, QoS differentiation may be augmented or achieved solely through service-type awareness, wherein the network or device dynamically determines the required handling priority based on the intrinsic characteristics of the payload or the application generating the traffic flow.

As previously described, to reduce or minimize control plane overhead, particularly in bandwidth-constrained or high-latency environments such as satellite transmission links, at least some of the described embodiments utilize a simplified QoS enforcement architecture. Specifically, at least some of the embodiments described eliminate the utilization of Evolved Packet System (EPS) bearer-level QCI parameters. For at least some of the described embodiments, traffic prioritization is instead pushed to the network layer via standard DSCP markings. To handle scenarios involving non-IP data transport or header removal (where DSCP markings may be unavailable over the air interface), the NB-IoT NTN utilizes service-type awareness logic. For an embodiment, this logic may comprise a Traffic Detection Function (TDF) or deep packet inspection (DPI) to identify the specific service type (e.g., voice media, IMS signaling, or best-effort data) directly from the application data stream, thereby applying the correct priority queueing without requiring explicit bearer QoS signaling. For an embodiment, the QoS mapping is then applied to internal configuration flags or custom Information Elements (IEs) in signaling messages to instruct the base station to prioritize IMS voice traffic based on the detected service type.

As previously described, at least some embodiments further include enabling downlink QoS prioritization of IMS voice services over an NB-IoT wireless link, including establishing a default data bearer between wireless device and a Packet Gateway (PGW) over the NB-IoT satellite NTN, marking outbound IP packets for IMS voice services with a Differentiated Services Code Point (DSCP) values indicative of high-priority, latency-sensitive traffic, transmitting the DSCP-marked IP packets over the default data bearer to the base station, inspecting the DSCP values at the base station to classify incoming packets into scheduling queues based on a DSCP-to-priority mapping policy, and scheduling and transmitting the packets to the wireless device, wherein IMS voice packets are assigned to a high-priority transmission queue. For an embodiment, the DSCP value for IMS voice packets is set to Expedited Forwarding (EF) and the DSCP value for IMS signaling packets is set to Assured Forwarding (AF). For an embodiment, the base station assigns IMS voice packets marked with DSCP EF to a latency-optimized scheduling queue for reduced transmission delay. At least some embodiments further include applying Medium Access Control (MAC) and Radio Link Control (RLC) parameters, including scheduling class settings, based on the DSCP classification to enhance priority handling of IMS voice traffic.

At least some embodiments further include discovering codec capabilities of endpoints in an IP Multimedia Subsystem (IMS) or Session Initiation Protocol (SIP) network of the NB-IoT satellite NTN, including receiving a SIP REGISTER message from a registering wireless device registering with an IMS network; (wherein the IMS network is at the application layer at the core network of the NB-IoT NTN access to support call session control), inspecting one or more SIP headers included in the SIP REGISTER message, the headers comprising at least one of a User-Agent header, device-type identifier, or vendor-specific extension, mapping the inspected one or more SIP headers to a known device profile associated with codec capability information, determining codec capabilities of the registering wireless device based on the mapped device profile, and using the determined codec capabilities to select a codec for use in a call between the UE and a remote endpoint. For at least some embodiments, an IMS network or IP Multimedia Subsystem network includes an architectural framework operating at the application layer, situated within or communicatively coupled to the core network. In the context of the described NB-IoT Non-Terrestrial Network (NTN) access, the IMS network provides centralized call session control and routing to support multimedia communications, such as evaluating SIP REGISTER messages and establishing sessions over the satellite transmission link.

In existing cellular systems such as LTE, bearer-level QoS is managed using dedicated EPS bearers, each associated with a specific QoS Class Identifier (QCI). This allows fine-grained control over traffic prioritization, delay budgets, and guaranteed bit rates for different services, such as voice, video, or signaling. However, when NB-IoT is used as the radio access technology (RAT), such bearer-level QoS mechanisms are not supported. NB-IoT only supports default bearer setup and does not provide the ability to establish dedicated bearers or assign multiple QCIs to different traffic flows.

As a result, all services, regardless of their transport requirements, must share the same default bearer, which typically has non-GBR characteristics and minimal QoS differentiation. While a QCI value is technically assigned to this default bearer, it serves more as a static identifier rather than enabling dynamic QoS enforcement. This lack of bearer-level QoS support creates a significant limitation, particularly in use cases such as voice over satellite, where different packet types (e.g., voice media vs. signaling) may have distinct delay, jitter, and reliability requirements. Without native support for QoS-aware bearer management, NB-IoT networks are unable to guarantee service quality for latency-sensitive or prioritized traffic.

To overcome this limitation, described embodiments introduce alternative methods to enable a QoS-aware framework adapted to NB-IoT over GEO satellite. These methods enable differentiated treatment for IMS session traffic over NB-IoT NTN via GEO satellite. In various embodiments, the present disclosure provides multiple approaches to enable differentiated QoS treatment for IMS voice traffic transmitted over NB-IoT RAT via GEO satellite links.

### Method 1: Existing or New QCI for GEO-Based IMS Voice

For an embodiment, either an existing or newly defined QCI may be assigned to IMS voice traffic over NB-IoT operating via GEO satellite links, with example characteristics provided in Table 2. This QCI is applied to the default bearer associated with a dedicated Access Point Name (APN) configured specifically for IMS services. The QCI parameters are optimized to meet the performance requirements of conversational voice in high-latency, narrowband environments. These parameters include the QCI value itself, the Allocation and Retention Priority (ARP), and the Maximum Aggregated Bit Rate (AMBR) for all non-GBR bearers.

TABLE 2
Example Characteristics of the New QCI for IMS over NB-IoT GEO

| Parameter | Value | Description |
|---|---|---|
| QCI Value | 85 (example assignment) | New QCI number for this specific |
| | | service class |
| Resource Type | Non-GBR | Due to NB-IoT limitations (no GBR |
| | | bearers) |
| Priority Level | 3 (example priority level) | Higher priority than standard |
| | | background traffic |
| Packet Delay Budget | 1000 ms (example packet delay | Reflects GEO round-trip latency |
| | budget) | budget |
| Packet Error Loss | 10⁻³ (example packet error loss | Suitable for conversational voice |
| Rate (PELR) | rate) | quality |
| Applicable Services | IMS voice media and signaling | Applied at default bearer level via |
| | | dedicated APN |
| RLC Mode | RLC UM (media), RLC AM | Indicates preferred configurations on |
| | (signaling) | the eNodeB |

For this embodiment, the eNodeB (base station) is enhanced to interpret the assigned QCI and apply corresponding scheduling behavior, such as prioritization in the MAC scheduler, reduced HARQ retransmission delay, and appropriate RLC configuration. Furthermore, the QCI, either an existing or a newly defined value (e.g., QCI 85), is assigned during the establishment of the default bearer associated with an IMS-specific APN. The Packet Gateway (PGW) is provisioned with a QoS profile that includes the designated QCI. When a PDN connectivity request is received for the IMS APN, the PGW allocates bearer resources according to this profile. The Mobility Management Entity (MME) includes the specified QCI in the bearer context setup message sent to the eNodeB (base station). This mechanism ensures that all traffic associated with the IMS APN is treated in accordance with the QoS characteristics of the selected QCI, without requiring explicit signaling from the User Equipment (UE).

To support the use of this QCI for IMS voice over NB-IoT via GEO satellite, the following methods can be employed:
1. APN-Based Configuration in the PGW.
   The QCI is provisioned as part of the PGW's configuration for the IMS-specific APN.
   When the UE initiates a PDN connectivity request to this APN, the PGW responds with bearer parameters that include the designated QCI.
   The MME includes this QCI in the EPS bearer context setup sent to the eNodeB (base station).
   This allows the eNodeB (base station) to apply appropriate scheduling and QoS treatment based on the QCI characteristics.
2. Predefined QCI Mapping via Subscription Profile
   The Home Subscriber Server (HSS) or Policy and Charging Rules Function (PCRF) may include subscription-specific rules that map APNs or service types to specific QCI values.
   Upon UE (wireless device) attachment, the MME retrieves these rules and applies the appropriate QCI during bearer setup.
3. UE-Initiated QCI Indication
   The UE (wireless device) may include a Traffic Flow Template (TFT) or QoS parameters in the PDN connectivity request to indicate its desired QoS.

In more detail, the bearer setup process proceeds as follows:
1. Upon initial attach or during a PDN connectivity procedure, the UE (wireless device) requests to establish a session to an APN configured for IMS voice services. The APN may be explicitly indicated by the UE (wireless device) or implicitly selected based on operator policy.
2. The MME receives the request and queries the HSS to retrieve the subscriber profile, including permitted APNs and QoS rules.
3. The PGW processes the request and applies the QoS profile associated with the IMS APN. This includes the specified QCI (existing or new), ARP, and optionally other parameters such as Maximum Bit Rate (MBR). Guaranteed Bit Rate (GBR) is typically not supported for NB-IoT.
4. The PGW initiates the creation of the default bearer using the configured QCI. The bearer context is returned to the MME in the Create Session Response.
5. The MME includes the QCI in the EPS bearer context setup message sent to the eNodeB (base station). Although NB-IoT supports only a default bearer, this QCI assignment enables the eNodeB (base station) to apply differentiated scheduling and radio resource behavior based on the QCI value. For example, the eNodeB (base station) may allocate higher scheduling priority, configure RLC mode (such as AM or UM), adjust HARQ retransmission timing, or prioritize the associated traffic class in its internal MAC-level queues.
6. Upon successful allocation of radio resources by the eNodeB (base station), the EPS bearer is established between the UE and PGW. All user-plane traffic associated with IMS voice over NB-IoT GEO satellite is transmitted over this bearer and is handled according to the parameters defined by the new QCI. This provides a mechanism for QoS-aware service differentiation without requiring additional bearers or modifications to the UE protocol stack.

This setup process allows operators to enforce QoS for satellite-based IMS voice services using standardized core-network mechanisms, with minimal complexity and no changes required to the NB-IoT UE (wireless device) or NAS signaling procedures.

Method 2: Dedicated APN without Explicit QCI Value

For an embodiment, QoS differentiation for IMS voice services over NB-IoT via GEO satellite is achieved without introducing a new QCI value. Instead, this embodiment leverages existing core network configuration capabilities and service context indicators to provide preferential treatment for latency-sensitive traffic, even in the absence of IP-layer mechanisms.

For an embodiment, a dedicated APN is provisioned specifically for IMS voice services. When a UE (wireless device) establishes a PDN connection to this APN, the MME applies internal configuration flags based on service context indicators, such as the designated IMS-specific APN (e.g., ims.nbiot), the Radio Access Technology (RAT) type being NB-IoT, or the UE's location context indicating operation within a GEO-NTN zone.

For an embodiment, these indicators prompt the MME to assign internal flags or custom information elements (IEs) within signaling messages, such as the Initial Context Setup Request or E-RAB Setup Request to the eNodeB (base station), or the NAS-level Activate Default EPS Bearer Context Request with Attach Accept message. These flags guide the treatment of the associated bearer, enabling differentiated handling without the need for IP-layer inspection.

For an embodiment, the eNodeB (base station) interprets these indicators and applies differentiated treatment to the default bearer. This may include higher scheduling priority or reclassification of the UE into a preferred access category, internal buffering strategies or discard priority adjustments, or use of modified HARQ or MAC scheduling behavior, if supported by the RAN implementation.

For an embodiment, the bearer is established using a standard QCI (e.g., QCI 9), but receives enhanced service based on network-side interpretation of service type and transport-level indicators. This embodiment does not rely on changes to QCI definitions or GBR configurations. Instead, it enables implicit prioritization based on service intent, using existing network procedures and configuration data. In this context, the QoS profile associated with the dedicated IMS APN may include parameters such as Allocation and Retention Priority (ARP), Maximum Bit Rate (MBR), UE-AMBR, and APN-AMBR values. These parameters, together with service-type awareness, allow differentiated treatment of IMS voice traffic over NB-IoT GEO links without requiring modification to the UE or QCI tables. An example procedure proceeds as follows:
1. The UE (wireless device) initiates a PDN connection for the dedicated IMS APN (e.g., ims.nbiot) via the NB-IoT RAT.
   The MME processes the PDN connection request, identifying the service type based on the APN configuration (IMS service) and/or RAT type (NB-IoT) and determines that this service requires special QoS handling.
   The MME applies internal flags or custom information elements (IEs) in the signaling messages, such as the Initial Context Setup Request or the E-RAB Setup Request, or in the NAS-level Activate Default Bearer Request.
2. The MME, recognizing the need for preferential treatment, signals the eNodeB via the signaling messages. The signaling may indicate service-specific treatment, such as:
   IMS voice service
   Location context in a GEO-NTN zone
   RAT type as NB-IoT
   These flags or IEs guide the eNodeB in determining how to treat the bearer for the associated IMS voice service, including higher priority scheduling and resource allocation.
3. The eNodeB receives the signaling and interprets the internal flags or custom IEs. The eNodeB applies differentiated treatment to the default bearer, including assigning a higher priority to the scheduling of the voice traffic (e.g., IMS voice media), adjusting internal buffering or discard priority, or optionally, modifying HARQ or MAC scheduling, where supported by the RAN implementation.
4. A default bearer (with standard QCI, e.g., QCI 9) is established for the UE's IMS voice service. The bearer is used to carry IMS traffic, but with the prioritization and service treatment determined by the MME and eNodeB based on the service intent and network configuration, rather than through changes to the QCI value.
5. The QoS profile for IMS voice traffic over NB-IoT GEO links is configured with parameters such as allocation and Retention Priority (ARP), maximum Bit Rate (MBR), UE-AMBR (User Equipment Aggregate Maximum Bit Rate), or APN-AMBR (Access Point Name Aggregate Maximum Bit Rate).

For an embodiment, these parameters, combined with the service-type awareness (e.g., IMS voice service), ensure differentiated treatment of IMS traffic over the NB-IoT GEO network, without the need for modifying the UE or QCI tables.

Method 3: ENodeB-Level DSCP-to-Scheduling Mapping (QoS without QCI)

This embodiment assumes IMS voice and signaling traffic is delivered over IP-based user plane bearers. In configurations where User Plane NIDD is used, IP-layer mechanisms such as DSCP marking are not applicable, and alternative prioritization techniques—such as bearer-level configuration or RLC/MAC-level adaptation—must be employed. For at least some embodiments, differentiated transmission priority for IMS voice traffic is achieved without introducing new QCI values or modifying the NAS bearer architecture. Instead, the eNodeB (base station) is enhanced to inspect Differentiated Services Code Point (DSCP) markings in IP packet headers and apply internal traffic classification based on a configurable mapping table. This enables per-packet prioritization within the RAN, simulating bearer-level QoS behavior while preserving compatibility with NB-IoT's single default bearer constraint.

This embodiment supports both downlink and uplink prioritization, with example procedures proceed as follows:
1. The UE initiates a PDN connection using a designated APN for IMS voice service (e.g., ims.nbiot) over the NB-IoT RAT. The MME processes the PDN connectivity request and initiates standard bearer setup. A default bearer is established between the UE and the PGW with a conventional QCI (e.g., QCI 9), without dedicated GBR or bearer-level QoS. No explicit NAS signaling for priority or service type is used; bearer treatment is best effort from a standards point of view.
2. IMS core entities (e.g., P-CSCF or application servers) generate downlink IP packets (signaling and voice media). The PGW or another upstream function applies DSCP markings to these packets:
   Voice media packets→DSCP EF (Expedited Forwarding)
   IMS signaling→DSCP AF classes.
   Background traffic→Default DSCP or BE (Best Effort).
   Packets are routed through the default bearer toward the UE.
3. The eNodeB inspects the DSCP field in each downlink IP packet, based on local DSCP-to-priority mappings:
   EF-marked packets are classified into high-priority transmission queues.
   AF or BE-marked packets are placed into medium or best-effort queues.
   Prioritized packets benefit from latency-sensitive scheduling and internal resource prioritization.
4. On the uplink, the UE marks outgoing IP packets (voice media or signaling) with DSCP values corresponding to their traffic class. These packets are encapsulated in uplink RLC PDUs and sent over the default bearer. Upon receipt, the eNodeB inspects the IP headers (available within the user plane payload) and extracts the DSCP value. The eNodeB uses the same DSCP mapping table to classify uplink packets into internal scheduling queues. Uplink packets marked with EF (e.g., voice media) are given preferred scheduling and transmission timing, improving latency and jitter.
5. In both directions, the DSCP-based prioritization is handled internally by the eNodeB's scheduler. The use of DSCP requires no modification to NAS signaling, bearer setup, or the UE's subscription profile.

This solution is compatible with existing NB-IoT bearer architecture and is transparent to the UE while enabling QoS-like treatment for IMS services.

### Codec Capabilities Negotiation

As previously described, at least some embodiments further include discovering codec capabilities of endpoints in an IP Multimedia Subsystem (IMS) or Session Initiation Protocol (SIP) network of the NB-IoT satellite NTN, including receiving a SIP REGISTER message from a registering wireless device registering with an IMS network; (wherein the IMS network is at the application layer at the core network of the NB-IoT NTN access to support call session control), inspecting one or more SIP headers included in the SIP REGISTER message, the headers comprising at least one of a User-Agent header, device-type identifier, or vendor-specific extension, mapping the inspected one or more SIP headers to a known device profile associated with codec capability information, determining codec capabilities of the registering wireless device based on the mapped device profile, and using the determined codec capabilities to select a codec for use in a call between the UE and a remote endpoint. For at least some embodiments, an IMS network or IP Multimedia Subsystem network includes an architectural framework operating at the application layer, situated within or communicatively coupled to the core network. In the context of the described NB-IoT Non-Terrestrial Network (NTN) access, the IMS network provides centralized call session control and routing to support multimedia communications, such as evaluating SIP REGISTER messages and establishing sessions over the satellite transmission link.

As previously described, for an embodiment, the IMS network includes an application-layer subsystem associated with the core network that supports IP-based multimedia services and call session control. Unlike traditional terrestrial broadband access, the present embodiments interface the IMS network through an NB-IoT satellite NTN access. Consequently, the IMS network acts as the application-layer intelligence for session management (e.g., processing SIP REGISTER messages and managing user profiles) while relying on the underlying, optimized, signaling-reduced transport mechanisms (such as non-IP transport or header removal) to communicate with the registering wireless device.

As previously described, for an embodiment, the mapping is performed using a codec profile database, the database storing predefined codec capability profiles corresponding to known device types. For an embodiment, a device type is defined or includes a device that supports IMS voice for NB-IoT NTN access. For an embodiment, the NB-IoT NTN is configured to utilize a codec profile database to perform local codec resolution without requiring end-to-end negotiation. For an embodiment, the database stores predefined codec capability profiles that are mapped to specific, known device types. By identifying the device type of an incoming connection request, the system can retrieve the corresponding codec profile to determine the supported media formats. Examples of device types may include classifications based on 3GPP standards, such as Category NB1 (Cat-NB1) or Category NB2 (Cat-NB2) devices, or specifically designated Non-Terrestrial Network User Equipment (NTN UE) classes. Furthermore, device types may be categorized based on their network provisioning capabilities, such as devices provisioned for IMS voice over NB-IoT NTN access, versus devices provisioned exclusively for non-voice signaling or Short Message Service (SMS) data. Additionally, device types may correspond to specific form factors or use cases deployed within the satellite coverage area, including but not limited to: emergency or SOS beacons requiring highly reliable low-bitrate voice codecs; maritime or asset tracking modules; wearable communication devices; and remote industrial sensors configured for exception-based audio or data reporting. At least some embodiments include identifying the known device type is achieved by extracting a device identifier from the signaling messages (e.g., from a SIP REGISTER message or initial network attachment signaling) and querying the codec profile database using the extracted identifier. The device identifier may comprise an International Mobile Equipment Identity (IMEI), an IMEI Software Version (IMEI-SV), a Permanent Equipment Identifier (PEI), a Media Access Control (MAC) address, or any other unique hardware or logical identifier associated with the endpoint. For an embodiment, the NB-IoT NTN is configured to parse the wireless device identifier to determine the specific commercial make and model of the wireless device. For example, the network may extract the Type Allocation Code (TAC) from the device's IMEI. Because the TAC uniquely corresponds to a specific manufacturer and model (e.g., a specific iteration of a smartphone manufactured by Apple Inc. or Samsung Electronics), the codec profile database can map the TAC directly to a predefined list of audio and video codecs hardcoded into that specific device model by the manufacturer. This allows the NB-IoT NTN to know with absolute certainty that a wireless device supports a specific codec (e.g., AMR-WB or EVS) without requiring the device to explicitly declare its capabilities in an SDP offer.

As previously described, for at least some embodiments further include transmitting, by the wireless device, a SIP OPTIONS request to a remote endpoint (end point that the wireless device is communicating with), receiving, by the wireless device, a SIP OPTIONS response including a Session Description Protocol (SDP) body identifying one or more codecs supported by the remote endpoint, and selecting, by the wireless device, a codec for use in a subsequent call based on the supported codecs listed in the SDP body. For an embodiment, the ‘SIP OPTIONS’ message refers to an application-layer signaling request utilized to query the capabilities, supported methods, and operational status of a target endpoint or network node prior to, or independently of, establishing a communication session. For an embodiment, in an IP Multimedia Subsystem (IMS) architecture, a ‘SIP OPTIONS’ request is a signaling method defined by the Session Initiation Protocol used to discover the capabilities of a User Agent (UA) or proxy server. The response to a SIP OPTIONS message typically includes a Session Description Protocol (SDP) body detailing the media types, audio/video codecs, and SIP extensions supported by the queried endpoint. For an embodiment, the SIP OPTIONS request is transmitted prior to initiation of a SIP INVITE message, thereby allowing codec determination prior to session establishment.

As previously described, for at least some embodiments further include determining codec capabilities of the wireless device using static device profiles, including storing, by the core network, a plurality of static device profiles in a codec capability database, each profile including a list of supported codecs for a corresponding device type, identifying, by the core network, a device type of the UE from a SIP REGISTER or SIP INVITE message, matching, by the core network, the identified device type to a corresponding static device profile, and selecting, by the core network, a codec for use in a session involving the wireless device based on the matched device profile. For an embodiment, the static device profiles are provisioned and updated based on device type, manufacturer information, or subscription data, and are maintained as part of a device management function.

As previously described, for at least some embodiments further include inferring codec capabilities of an endpoint based on historical data, including maintaining, by the core network, a cache of codec usage history for one or more endpoints, identifying, by the core network a previously used codec for a given endpoint from the history cache, and selecting, by the core network the previously used codec as a preferred codec for a new call involving the same endpoint. At least some embodiments further include updating the codec usage history cache upon completion of each call and retaining cached data for a configurable duration or number of past sessions.

As previously described, for at least some embodiments further include determining codec capabilities of endpoints in the NB-IoT satellite NTN, including inspecting, by a SIP Back-to-Back User Agent (B2BUA) Interworking Function (IWF) of the core network, SIP REGISTER messages, SIP OPTIONS messages, or previously stored device profiles, storing, by a database of the core network, static device profiles and/or codec usage history for multiple endpoints, determining, by a codec selection module of the core network, codec capabilities from inspected SIP headers, SIP OPTIONS responses, or stored profiles, and initiating or managing, by a communication interface of the core network, a call between endpoints using a codec selected by the codec selection module. For an embodiment, the codec selection module is further configured to prioritize dynamic codec discovery using SIP OPTIONS requests and to store results for reuse in subsequent calls.

As previously described, for at least some embodiments further include minimizing codec negotiation delays, including sending, by the wireless device, a SIP OPTIONS request to a target endpoint of the core network, the base station, a core network node, or an IWF node of the core network, receiving, by another wireless device, the core network node, or the IWF node of the core network, a SIP OPTIONS response including an SDP body that identifies supported codecs back from the target endpoint of the core network, storing, by the wireless device, the core network node, or the IWF node of the core network, the identified codec list in a local cache, and retrieving, by another wireless device, the core network node, or the IWF node of the core network, the cached codec list for future session setups with the same endpoint, thereby reducing the need for repeated codec negotiation. For an embodiment, the cached codec list is retained for a predefined time interval or until a detected update to the endpoint's capabilities triggers invalidation or refresh of the stored data.

### Codec Capabilities Negotiation

For an embodiment, to optimize call setup times and enhance media negotiation, an Interworking Function (IWF), acting as a SIP Back-to-Back User Agent (B2BUA), can proactively discover codec capabilities before initiating media negotiation. This approach significantly reduces delays during the call setup process, especially when dealing with media interworking scenarios. The callee, referring to the party receiving the call, is identified by the IWF to determine the codec capabilities of the endpoints involved in the session. The IWF can implement several SIP-compliant methods for codec discovery, all without requiring any changes to the protocol or the devices involved.

### Method 1: SIP REGISTER Inspection

One common approach involves leveraging SIP REGISTER messages, where the IWF inspects SIP headers (such as User-Agent, device type, or vendor-specific extensions) during UE registration with the IMS network. These headers often contain information that maps to known device profiles, which can indicate the supported codecs of the endpoint.

SIP REGISTER inspection is passive and occurs during the standard registration process. It does not introduce significant additional signaling or latency. This method requires no extra signaling beyond normal UE registration, making it suitable for environments with predictable devices and limited codec variations.

### Method 2: SIP OPTIONS Requests

Another effective method involves using SIP OPTIONS requests, where the IWF actively sends OPTIONS queries to the endpoints to solicit their supported codecs in real-time. The endpoint responds with an SDP body detailing the supported codecs, allowing the IWF to make an informed decision before proceeding with call setup.

SIP OPTIONS allows dynamic, real-time discovery of codec capabilities, making it more adaptable to changing endpoint profiles. This method is fully SIP-compliant and widely supported across different SIP-based systems. By querying endpoints before initiating a call, it reduces the need for multiple signaling exchanges, optimizing call setup and reducing overhead.

SIP OPTIONS introduces a small amount of additional signaling overhead compared to passive methods like SIP REGISTER. However, this overhead is minimal compared to the benefits of real-time codec discovery. While the method optimizes codec negotiation, the active querying can introduce slight delays in environments where immediate call setup is critical.

### Method 3: Static Device Profiles

In more controlled environments, such as enterprise networks, the IWF can rely on static device profiles to avoid the need for real-time discovery. These profiles are pre-configured with the codec capabilities of each endpoint, and the IWF selects codecs based on these predefined profiles during call setup.

Since the codec capabilities are known in advance, there is no need for runtime discovery, enabling immediate codec selection and minimal call setup delays. This method works well in environments with a limited set of known devices, such as managed enterprise networks or carrier-controlled environments.

### Method 4: Codec History Caching

The IWF can also implement codec history caching, where it tracks the codecs used in previous calls and uses this information to predict codec preferences for future calls. This method leverages historical data to reduce the time required for codec negotiation.

By inferring codecs from past calls, the IWF can speed up codec negotiation, especially in environments where endpoints consistently use the same codec. This method is particularly effective in scenarios such as call centers, where specific codecs are regularly used across multiple calls.

In this method, the IWF must maintain an up-to-date cache of codec preferences, which can introduce complexity and overhead in managing the cache.

### Adaptive Packet Enhancement

At least some embodiments further include enhancing Real-Time Transport Protocol (RTP) packet transmission over a wireless interface between the wireless device and the base station, including receiving, at the base station, a core network node, or an interworking function of the core network, a reduced RTP packet from the wireless device, wherein the reduced RTP packet omits at least one original RTP header field, generating, by the base station, the core network node, or the interworking function of the core network, one or more information elements (IEs) comprising supplementary metadata associated with the reduced RTP packet, and prepending the base station, the core network node, or the interworking function of the core network, the one or more information elements to the reduced RTP packet to form an enhanced RTP packet for downstream processing or delivery. At least some embodiments further include detecting, at the base station, the core network node or interworking function node of the core network, an absence of attached information elements, and in response, generating and prepending a dummy information element as a placeholder to maintain structural integrity. For an embodiment, the information elements (IEs) are prepended in an arbitrary order and are byte-aligned for parsing efficiency. For an embodiment, the enhanced RTP packet is transmitted to a downstream network function, wherein the network function utilizes the prepended information elements for at least one of jitter compensation, quality assessment, or media stream synchronization. For an embodiment, the reduced RTP packet is generated at the user equipment by removing one or more RTP header fields, including at least a timestamp field, prior to transmission over a constrained wireless link.

For an embodiment, each of the one or more information elements includes an IE header including an extension (E) bit indicating whether additional information elements follow a comprehension (C) bit indicating whether the information element is mandatory for correct decoding, an information element (IE) type field identifying the semantic category of the information element, a reserved field for future extensions, and a length field specifying the length of the IE body in octets. For an embodiment, each information element further comprises an IE body, a content of which is determined based on a corresponding IE type field. For an embodiment, information element (IE) includes a discrete, structured data field, parameter, or data block embedded within a larger communication or signaling message. An information element acts as a modular container utilized to convey a specific piece of control, configuration, or management information between a transmitting node and a receiving node. In the context of 3GPP, an information element refers to a standardized data structure utilized within signaling protocol messages, such as Radio Resource Control (RRC) or Non-Access Stratum (NAS) messages. Each IE encapsulates specific network parameters, capabilities, or state information required for protocol operation, allowing for extensible and modular message construction. For an embodiment, an information element header refers to the initial segment or metadata portion of an information element. The header provides parsing instructions to the receiving node, typically comprising an identifier (such as an IE type field) that indicates the classification or purpose of the information element, and optionally a length field indicating the size of the subsequent information element body. In the context of 3GPP, an ‘information element header’ refers to the leading bits or bytes of an information element utilized to facilitate Type-Length-Value (TLV) or Type-Value (TV) encoding. The header comprises an Information Element Identifier (IEI) or ‘IE type field’ which dictates how the protocol stack of the receiving entity should decode and interpret the payload encapsulated within the corresponding ‘IE body’. For an embodiment, at least one of the information elements includes a timestamp information element, the timestamp encoded as a 64-bit Unix epoch value in network byte order.

At least some embodiments further include enhancing RTP packet delivery, including generating and transmitting, by the wireless device, reduced RTP packets over a wireless interface between the wireless device and the base station, receiving, by the base station, a core network node, or an interworking function of the core network, the reduced RTP packets, generating, by the base station, the core network node, or the interworking function of the core network, one or more information elements comprising metadata associated with the original RTP structure, and prepending, by the base station, the core network node, or the interworking function of the core network, the one or more information elements to the reduced RTP packet to produce an enhanced RTP packet. At least some embodiments include parsing, by the base station, the core network node, or the interworking function node of the core network, the prepended information elements and utilizing the metadata for calculating jitter, reconstructing timestamps, or improving media playback quality. As described, at least some of the embodiments include core network nodes. At least some embodiment include putting the IWF in the P-CSCF of the IMS network, wherein P-CSCF is an existing network function in IMS. For an embodiment, the P-CSCF functionality is expanded to support interworking between I1 signaling and standard SIP signaling. Similarly, for voice packets, for an embodiment, the existing AGW function is expanded to support the IWF to support transcoding, media format conversion etc.

An embodiment includes encapsulating voice packets into the proposed Adaptive Packet Enhancement (APE) structure. These packets are delivered using UP NIDD delivery method as disclosed. To optimize data transmission over the air interface in GEO (Geostationary) environments, UE (wireless device) may strip essential header information, including timestamps, from RTP packets before transmission. While these timestamps are crucial for accurate jitter calculation at the eNodeB (base station), their removal can degrade voice quality and overall network performance. To mitigate this issue, an enhancement is introduced where the eNB and/or other network entities, such as an Interworking Function (IWF) as disclosed in this invention, utilize a new mechanism to inject supplementary data and ensure smooth and reliable RTP packet delivery.

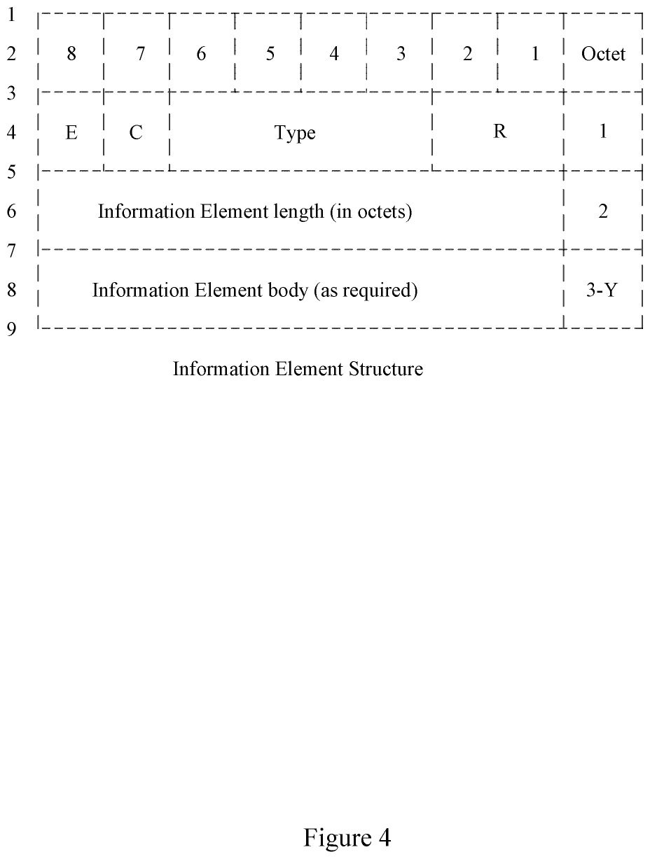

FIG. 4 shows a structure of information elements, according to an embodiment. The Adaptive Packet Enhancement (APE) format of the disclosed embodiments is designed to improve the handling of RTP packets between the eNB (base station) and the IWF. This format involves prepending specific bytes to the RTP packets. These prepended bytes are structured using Information Elements (IEs) as shown in FIG. 4.

For at least some embodiment, the Information Elements (IEs) structure is the foundation of the APE format. For an embodiment, each IE comprises two primary components, IE Header and IE Body. For an embodiment, the IE Header includes a two-octet field, encoded in binary format, and consists of the following fields:
Extension Bit (E): (Octet 1, bit 8), wherein this bit indicates whether another IE follows.
E=0: No further IE follows (this is the last IE).
E=1: Another IE is present.
Comprehension Bit (C): (Octet 1, bit 7), wherein this bit specifies whether understanding the IE is mandatory or optional.
C=1: The IE must be understood. If the decoder doesn't recognize the IE, the entire RTP packet (including the IE) is discarded.
C=0: The decoder can skip the IE and continue decoding subsequent IEs.
IE Type: (Octet 1, bits 6 to 3) which includes a 4-bit field that identifies the IE type. Up to 16 distinct types are supported, with potential types including timestamps, sequence numbers, packet arrival times, and quality metrics.
Reserved Bits (R): (Octet 1, bits 2 to 1), wherein these bits are reserved for future use.
Information Element Length: (Octet 2), wherein this field specifies the length of the IE Body in octets, encoded in binary format.

For an embodiment, the IE Body follows the two-octet header and contains the actual data associated with the specific IE. The format and content of the body depend on the IE Type and, where applicable, the reserved bits.

Table 3 shows some examples of the types of IEs supported by the APE format.

| IE Type | Description | Comprehension |
|---|---|---|
| 0x0000 | Dummy IE element | Mandatory |
| 0x0001 | Unix epoch (in milliseconds) | Mandatory |
| | encoded in 64 bits | |

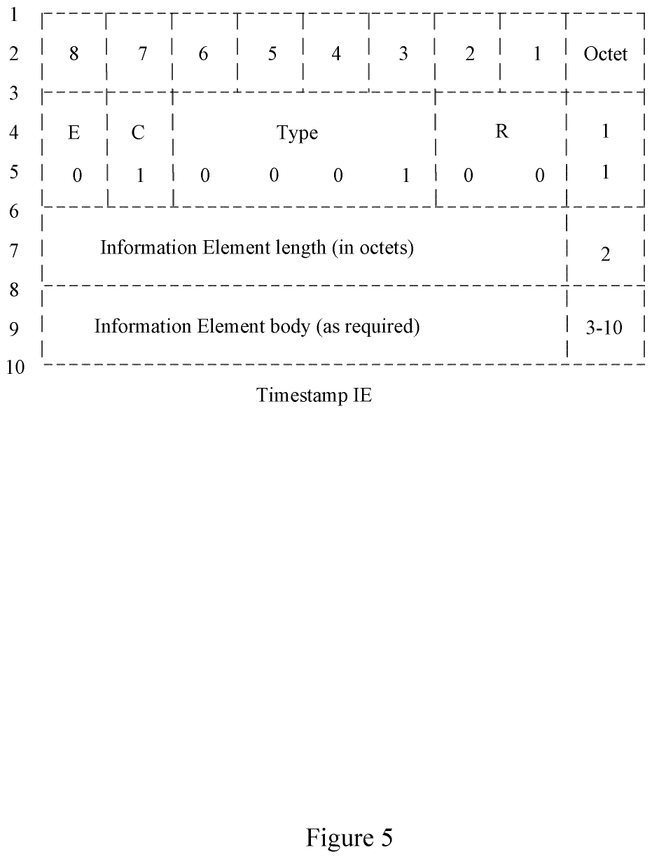

FIG. 5 shows a timestamp IE, according to an embodiment. The Timestamp IE, as shown in FIG. 5, contains the Unix epoch, measured in milliseconds, and is encoded as a 64-bit value in network byte order. The Unix epoch is defined as the number of seconds elapsed since 00:00:00 UTC on 1 Jan. 1970. This timestamp is crucial for accurate jitter calculation and network synchronization.

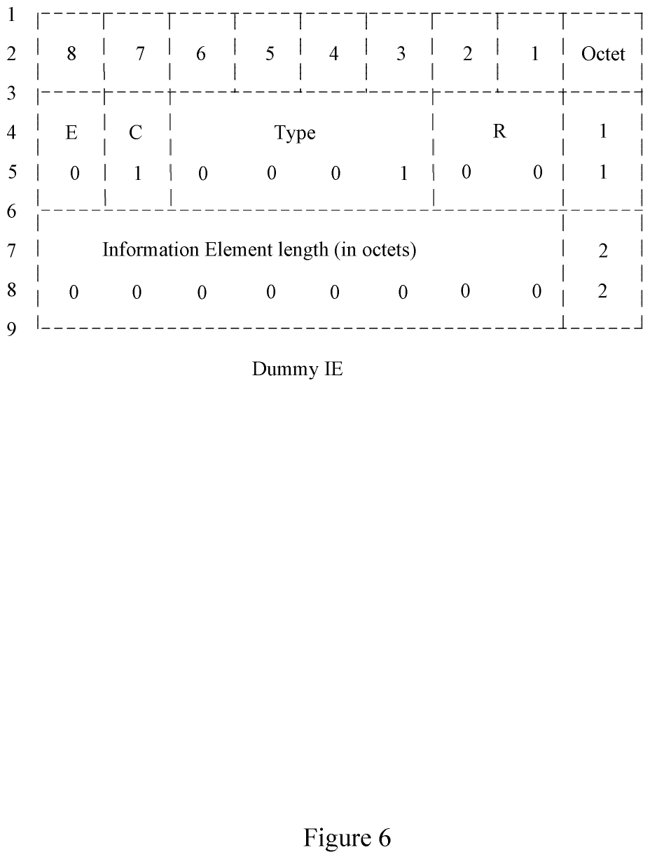

FIG. 6 shows a dummy IE, according to an embodiment. For an embodiment, the Dummy IE, as shown in FIG. 6, is used when no other IEs are included in the payload. It serves as a placeholder to maintain alignment in the packet structure. If included erroneously with other IEs, the decoder treats it like any other IE, ensuring compatibility.

For at least some embodiments, in the APE Format, each IE is byte-aligned, with padding bits added as necessary to ensure proper alignment. The IEs can appear in any sequence. Decoders should not assume a specific order of IEs, ensuring robustness across different deployments. The C bit and the Length field allow decoders to skip IEs they do not understand, facilitating forward compatibility. All IEs are encoded in network byte order (big-endian), a standard for network protocols, ensuring uniformity across diverse network elements.

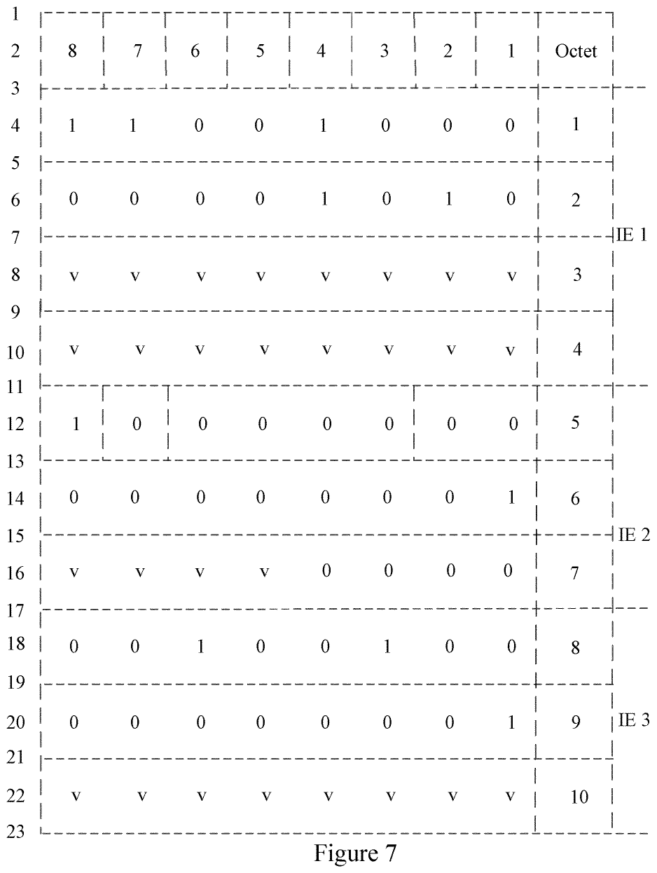

FIG. 7 shows APE encoding with three IEs, according to an embodiment. In FIG. 5, an example of APE Format Encoding is provided. In this example, three IEs are encoded into the structure:
IE 1: Type 2, Mandatory, 2 bytes long.
IE 2: Type 4, Optional, 4 bits long.
IE 3: Type 9, Optional, 1 byte long.

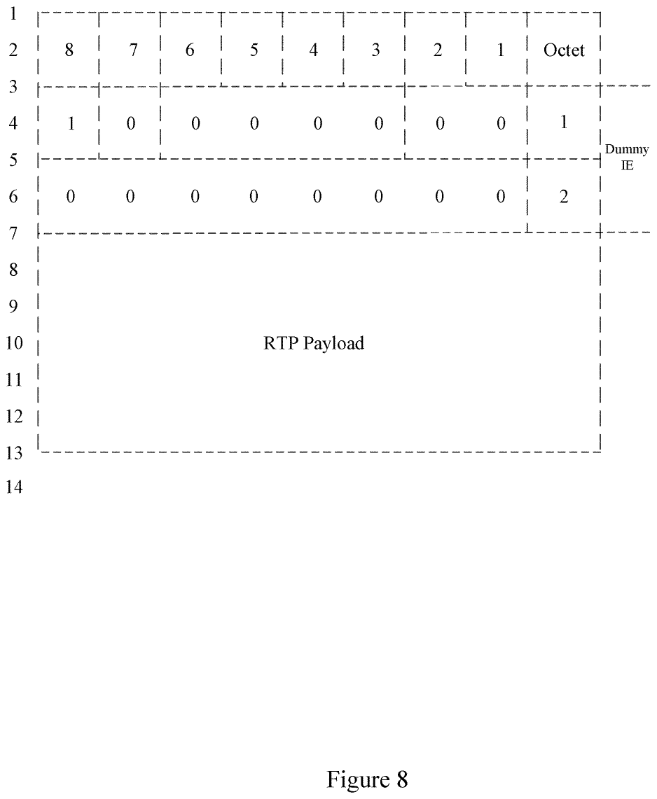

FIG. 8 shows APE encoding with a dummy IE, according to an embodiment. As shown in FIG. 8, when no other IEs are present, the payload consists of a Dummy IE followed by the respective IEs with their headers and values. The prepended bytes are encoded in sequence as per the respective IE headers.

For at least some of the embodiments described, the newly introduced Adaptive Packet Enhancement (APE) format is designed to improve the handling of RTP packets between the eNB (base station) and the IWF. For at least some embodiments, this format involves prepending specific bytes to the RTP packets. These prepended bytes are structured using Information Elements (IEs) as shown in FIG. 4.

### Procedures

### MO Call Procedures

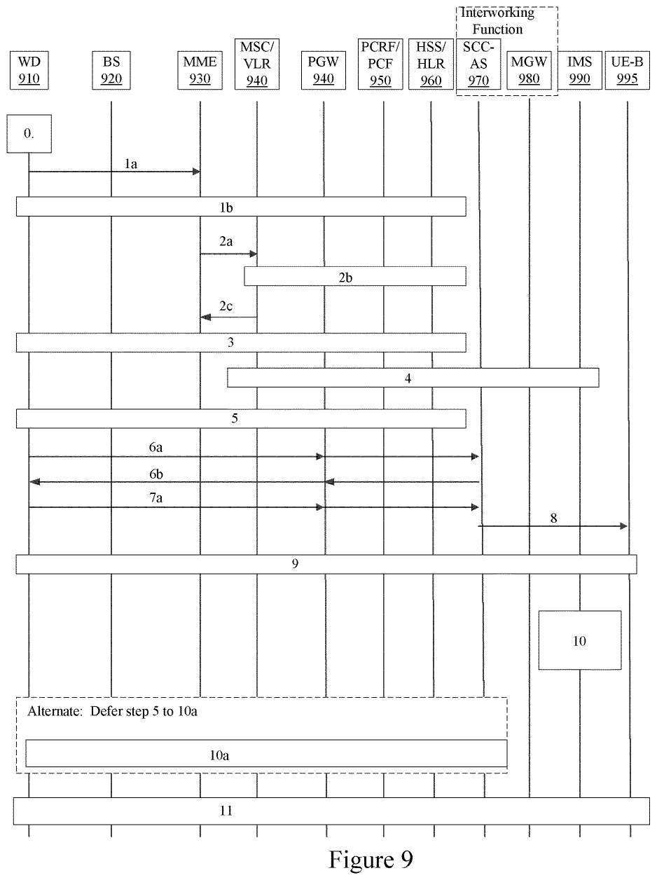

FIG. 9 shows a flow for MO call procedures, according to an embodiment. As shown, steps 0 through 11 include a Step 0 that includes the UE-A (wireless device) access IMS service over NB-IoT NTN via GEO with an indication to use IMS over UP NIDD APN, a Step 1a that includes the UE-A (wireless device) 910 initiating the attach procedure by the transmission of an Attach Request. The Attach Type indicates that the UE (wireless device) 910 requests a combined EPS/IMSI attach and informs the network that the UE (wireless device) 910 is capable and configured to use UP NIDD fallback for IMS voice via GEO, a Step 1b that includes steps 3 to 16 of the EPS Attached procedure as specified in TS 23.401, a Step 2a that includes the MME 930 sending a Location Update Request towards MSC/VLR 940 via SGs. A Step 2b includes the MSC/VLR 930 Server enhanced for ICS performs location update, authentication and obtains subscriber data. A Step 2c includes a Location Area Update Accept being returned to the MME 930. A Step 3 includes Steps 17 to 26 of the EPS Attached procedure as specified in TS 23.401, and the EPS Attach procedure is completed with default bearers, with the DRB for IMS I1 signalling. The methods disclosed can be used here to support QoS, either with explicit QCI or without explicit QCI. A Step 4 includes The MSC Server being enhanced for ICS decides to initiate IMS registration for this subscriber if the subscriber is not already registered. A Step 5 includes establishing the other default bearer for the RTP media session. This bearer supports the RTP media session and utilizes the previously described QoS mechanisms, either with or without an explicit QCI. The default bearer can be initiated by either the UE or the network. In the network-initiated case, upon receiving PCC rules from the PCRF, the PGW sends a Create Bearer Request to the SGW, which forwards it to the MME. The MME then sends an Activate Bearer Context Request to the eNB, which triggers an RRC Connection Reconfiguration message to the UE. The UE responds with RRC Connection Reconfiguration Complete, and the eNB acknowledges with an E-RAB Setup Response. In another embodiment, NB-IoT may be enhanced to support dedicated bearer setup. In this case, step 5 should be updated to state that a dedicated bearer is established for the RTP media session, following the procedures defined in 3GPP TS 23.401. For an embodiment, step 5 may be skipped and replaced by step 10a. A Step 6a includes the UE-A (wireless device) 910 initiating a call by sending an ICS Call Initiation Request over I1 reference point containing the UE-B address. A Step 6b includes the SCC AS sends the SCC AS PSI DN to the UE (wireless device) 910 over the I1 reference point. A Step 7a includes the UE-A (wireless device) 910 sending an I1 INVITE to the SCC AS with SCC AS PSI and SDP-MGW, e.g. codec supported, etc. A Step 8 includes the SCC AS 970 invoking a B2BUA, terminating the UE-A Leg and originating a leg for presentation of an IMS session towards UE-B (another wireless device) 995 on behalf of UE-A. The SCC AS 970 correlates the signalling session bearer (over UP-NIDD) with the IMS service control signalling session using the SCC AS PSI and creates a SIP INVITE containing the SDP received in the UP-NIDD I1 signalling path. The INVITE request is routed from the SCC AS to the IMS core where standard IMS originated session processing and routes the request onwards to the UE-B. A Step 9 includes completion of the Service Control Signalling Procedures. A Step 10a includes the MGW 980 determining, without further negotiation, whether a transcoding is necessary using the methods previously described, with the knowledge of both UE-A 910 and UE-B's 995 codec capabilities. Alternative establishment of a second default bearer or a dedicated bearer for a RTP media session can be deferred to step 10a. In that case, step 5 will be skipped and replaced by step 10a here. This deferred bearer setup may be triggered when UE-A receives a specific I1 message, such as I1 PROGRESS, I1 SUCCESS, etc. A Step 11 includes completion of Media Session Procedures. RTP media session proceeds with Adaptive Packet Enhancement as previously disclosed.

### MT Call Procedures

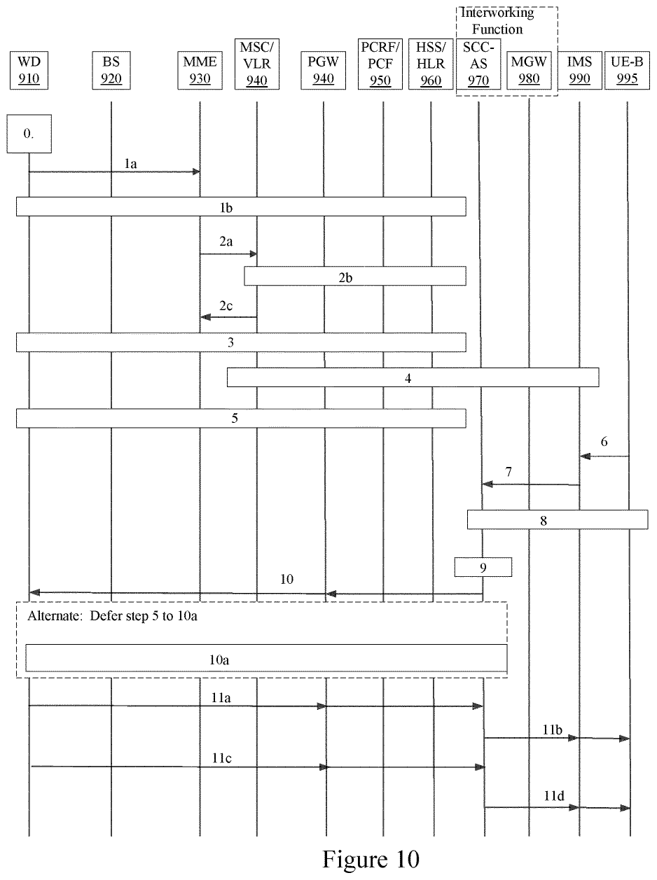

FIG. 10 shows a flow for MT call procedures, according to another embodiment. Steps 0 through 11 include the same steps 1-5 as the flow of FIG. 9, and steps 6-11 include a Step 6 that includes an incoming SIP INVITE being received at the IMS 990 core of the UE-A (wireless device) 910 party from UE-B (another wireless device) 995, a Step 7 that includes the IMS 990 core (e.g. S-CSCF) executing terminating initial Filter Criteria and forwards the SIP INVITE to the SCC AS 970, a Step 8 that includes the SCC AS 970 sending a Session Progress response to the IMS 990, and forwarding the Session Progress response to UE-B (other wireless device) 995, a Step 9 that includes the SCC AS 970 performing Terminating Access Domain Selection (T-ADS) and if informed of the UE-A (wireless device) 910 capability for I1 during IMS registration, choosing the NIDD UP domain for the setup of the media, a Step 10 that includes the SCC AS terminating the session from UE-B (other wireless device) 995 and establishes a new session over I1 by sending an Incoming Call Request to the UE-A via the HSS and MSC Server. For an embodiment, the Incoming Call Request may include an indication instructing UE-A to initiate the NIDD_IP bearer establishment procedure for either a second default bearer or a dedicated bearer to support the RTP media session. In this case, the bearer establishment is deferred to Step 10a, and Step 5 is omitted and replaced accordingly. This deferred setup may alternatively be triggered when UE-A receives other I1 messages, such as an I1 INVITE. Additionally, the Incoming Call Request may contain the SCC AS PSI DN, allowing the SCC AS to later correlate outgoing service control signalling with the incoming I1 control signalling over the NIDD-UP bearer. For an embodiment, steps 11a-11b include the UE-A (wireless device) 910 sending an I1 ALERT to the SCC AS 970, and the SCC AS 970 forwards SIP 180 Ringing message to UE-B (other wireless device) 995, and steps 11c-11d include the UE-A (wireless device) 910 sends I1 SUCCESS message to the SCC AS 970, and the SCC AS 970 forwards a SIP 200 OK message to UE-B (other wireless device) 995 in response to the INVITE received at step 7.

### Emergency Call Procedures

For an embodiment, if the SCC-AS detects an IMS emergency call over NIDD-UP via GEO, e.g. through emergency service indication in the initial I1 message or based on the dialed emergency number from an NB-IoT UE accessing via GEO NTN, it may interwork with IMS for routing the emergency session to the Public Safety Answering Point (PSAP). For an embodiment, if emergency registration is performed using the I1 interface toward the SCC-AS, and the SCC AS then proceeds to send the emergency session initiation request to the E-CSCF in the IMS core using standard SIP signalling, by following the architecture in FIG. 5. For an embodiment, if the SCC AS is required to handle anonymous emergency calls (e.g., due to local regulations), it shall skip the IMS registration step and directly send the anonymous emergency session initiation to the E-CSCF using SIP. The identity used may be derived from configuration or replaced with a temporary anonymous identifier as per IMS emergency call procedures. If the emergency session is tagged with eCall indication from the UE (wireless device) (e.g., via a special I1 information element), the SCC-AS may include the IMS eCall indication in the SIP INVITE to the E-CSCF. The Minimum Set of emergency related Data (MSD) shall be transferred via the User Plane NIDD media bearer. For an embodiment, the SCC AS and IMS shall transport the MSD data transparently end-to-end from UE to the PSAP, maintaining the format generated by the UE (wireless device). For a UE (wireless device) that has established a NIDD bearer with the SCC AS, but has not yet performed any form of logical registration for IMS service control (e.g., via I1), the SCC AS may follow a fallback behaviour equivalent to a non-enhanced interworking node, potentially routing the call using pre-configured emergency handling mechanisms or default service logic. It is further proposed that existing location services can be used to obtain the UE (wireless device) location (e.g., geographical location) meeting regulatory requirements, when the UE (wireless device) establishes an IMS emergency call over NB-IoT NTN via GEO satellite connecting to EPC.

For at least some embodiments, the same architecture can be extended to scenarios where a “fallback” to a constrained bearer path is required, yet IMS service control must still be maintained, for example, during emergency call handling. An MSC Server enhanced with IMS Centralized Services (ICS) and supporting the I6 interface can interwork with IMS to manage such emergency calls to the Public Safety Answering Point (PSAP) as follows:
If the MSC Server detects an emergency call, either due to a constrained fallback setup with emergency indication or the use of a locally defined emergency number, from a UE that has already registered via the I2 procedure, it shall perform an emergency registration to IMS over 12. This registration supports IMS emergency services. The MSC Server then initiates an emergency session establishment request to the E-CSCF over the I6 interface.
If local regulations permit anonymous emergency calls, the MSC Server shall bypass IMS registration and directly initiate an anonymous emergency session request to the E-CSCF via I6, without performing any registration procedure.
If the emergency call from the fallback domain includes an eCall indication (as provided by the UE), the MSC Server shall include the corresponding IMS eCall indication in the session establishment request to the E-CSCF via I6. The UE transmits the Minimum Set of Data (MSD) using in-band modem signaling, as specified for circuit-switched (CS) eCall. The MSC Server and IMS domain must ensure end-to-end delivery of the MSD, from the UE to the PSAP, in the format generated by the UE.
For a UE that is registered with the MSC Server but has not completed IMS registration via I2, the MSC Server shall revert to the behavior of a non-ICS-enhanced MSC Server when handling CS-domain emergency calls.

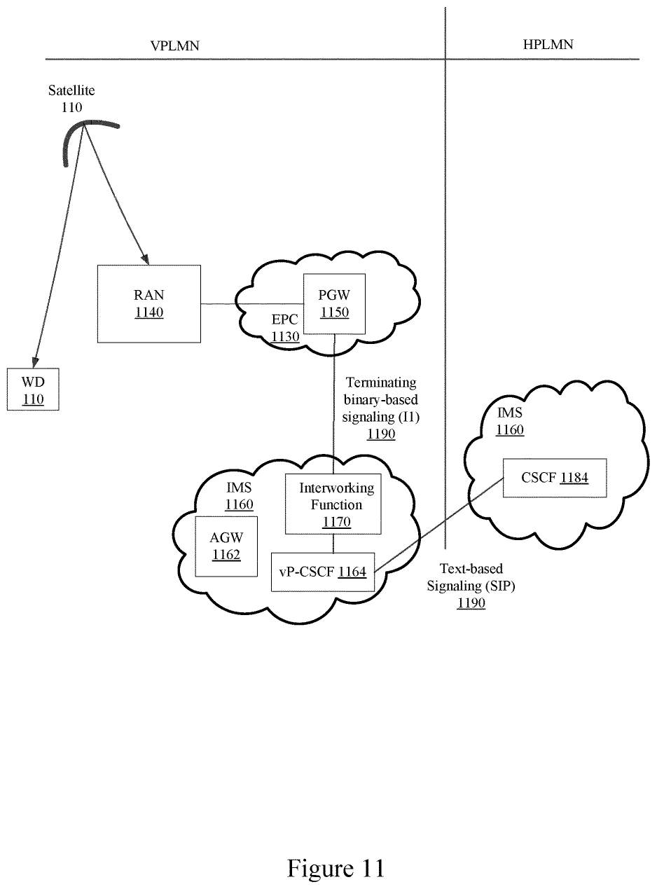

FIG. 11 shows an NB-IoT NTN, according to another embodiment. For an embodiment, FIG. 11 represents a Local Breakout (LBO) based deployment within a Narrowband Internet-of-things (NB-IoT) satellite Non-Terrestrial Network (NTN), wherein specific architectural components are situated within a Visited Public Land Mobile Network (VPLMN) while leveraging an IP Multimedia Subsystem (IMS) core located in a Home Public Land Mobile Network (HPLMN). For an embodiment, the NB-IoT NTN operates by bifurcating communication into specialized signaling and media paths to mitigate the technical constraints of high-latency satellite links. A Wireless Device (WD) 110 wirelessly interfaces with a Radio Access Network (RAN) 1140 via wireless links through a Satellite 110 and initiates a session by transmitting binary-based signaling (I1) 1190, terminating at the Interworking Function (IWF) 1170 deployed at the VPLMN. This signaling is communicated across the RAN 1140 to the Evolved Packet Core (EPC) 1130, wherein a Packet Data Network Gateway (PGW) 1150 serves as the anchor point for the user plane within the VPLMN.

For an embodiment, the I1 signaling messages are received by an Interworking Function (IWF) 1170 situated within the VPLMN IMS 1160. The IWF 1170 operates as a Back-to-Back User Agent (B2BUA) to translate binary I1 messages into standard Text-based Signaling (SIP) 1190 for integration with the IMS core. Within the VPLMN, the architecture further comprises a Visited Proxy Call Session Control Function (vP-CSCF) 1164 located in VPLMN, which serves as the primary signaling contact point in the visited network, and an Access Gateway (AGW) 1162 expanded to support interworking, transcoding, and media format conversion.

For an embodiment, simultaneously, voice traffic is handled via Media Packets Data Transport utilizing a second, prioritized Data Radio Bearer (DRB), wherein media flows from the WD 110 through the PGW 1150 as non-IP data transport, Non-IP Data Delivery (NIDD) or voice data packets with IP/UDP header removed before being processed by the AGW 1162. To facilitate session management and routing, the vP-CSCF 1164 interfaces across the network boundary with the IMS 1160 of the HPLMN, specifically reaching a Call Session Control Function (CSCF) 1184. The CSCF 1184 serves as a central signaling node responsible for SIP registration and routing in the home network, ensuring that multimedia requests are correctly processed and directed between endpoints or application servers. This configuration enables the NB-IoT NTN to facilitate seamless call integration between constrained satellite links in a visited territory and the standard IP infrastructure of the home network.

Although specific embodiments have been described and illustrated, the embodiments are not to be limited to the specific forms or arrangements of parts so described and illustrated. The embodiments described are to only be limited by the claims.

What is claimed:

1. A method for supporting IP Multimedia Subsystem (IMS) voice services over a Narrowband Internet-of-things (NB-IoT) Satellite Non-Terrestrial Network (NTN), comprising:
establishing, by a core network of the NB-IoT satellite NTN, for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device;
wherein a wireless device is configured to support IMS voice communication over the NB-IoT satellite NTN, comprising:
establishing, by the wireless device, the two separate DRBs for an IMS voice session including the first DRB for transporting the signaling traffic and a second DRB for transporting the voice media packets;
sending, by a data transport, at least one of the signaling traffic or the voice media packets with non-IP packets;
configuring, by the wireless device, a radio link control (RLC) acknowledged mode for the signaling traffic and an unacknowledged mode for the voice media packets; and
initiating, by a control module of the wireless device, an IMS session setup using signaling, wherein the signaling includes messages to support call set up, release, modifications, and call registration, and wherein the signaling traffic includes data streams that include the messages.

2. The method of claim 1, wherein the data transport uses RLC acknowledged mode (AM) for the signaling and RLC unacknowledged mode (UM) for the voice media packets.

3. The method of claim 1, further comprising:
utilizing, by the core network of the NB-IoT satellite NTN, an interworking function (IWF) to translate the signaling and the voice media packets for communication with standard IMS network components;
wherein the interworking function performs codec resolution by extracting codec information from I1 and/or SIP signaling and performing local transcoding, thereby eliminating end-to-end codec negotiation.

4. The method of claim 1, further comprising providing Quality of Service (QoS) differentiation for IP Multimedia Subsystem (IMS) voice services over the NB-IoT NTN, comprising:
establishing a default data bearer between the wireless device and a Packet Gateway (PGW) over an NB-IoT radio access network (RAN);
associating a predefined Quality of Service Class Identifier (QCI) value with the bearer for prioritization of IMS voice traffic;
applying a QoS policy at the NB-IoT RAN based on an association with the predefined QCI value to enable differentiated handling of IMS voice traffic relative to other data traffic; and
forwarding IMS voice packets with the predefined QCI value over the default data bearer to enable low-latency and high-priority transmission.

5. The method of claim 4, wherein the predefined QCI value assigned for IMS voice traffic is selected to provide low-latency and high-priority handling though other standardized or operator-defined QCI values suitable for IMS voice.

6. The method of claim 4, wherein a QoS policy includes applying scheduling prioritization for IMS voice traffic at the base station based on the predefined QCI value.

7. The method of claim 1, further comprising providing QoS differentiation for IMS voice services over NB-IoT, comprising:
provisioning a dedicated Access Point Name (APN) for IMS voice services; detecting a Packet Data Network (PDN) connection request from the wireless device to the dedicated APN for IMS voice services;
applying Differentiated Services Code Point (DSCP) markings to outbound IP packets from a Packet Gateway (PGW), wherein IMS voice media packets are marked with a high-priority DSCP value;
establishing a default data bearer for the wireless device over an NB-IoT wireless link; and
interpreting the DSCP markings at a RAN (NB-IoT radio access network) to apply differentiated treatment for the IMS voice traffic, including prioritization in radio scheduling.

8. The method of claim 7, further comprising enabling downlink QoS prioritization of IMS voice services over an NB-IoT wireless link, comprising:
establishing a default data bearer between wireless device and a Packet Gateway (PGW) over the NB-IoT satellite NTN;
marking outbound IP packets for IMS voice services with a Differentiated Services Code Point (DSCP) values indicative of high-priority, latency-sensitive traffic;
transmitting the DSCP-marked IP packets over the default data bearer to the base station;
inspecting the DSCP values at the base station to classify incoming packets into scheduling queues based on a DSCP-to-priority mapping policy; and
scheduling and transmitting the packets to the wireless device, wherein IMS voice packets are assigned to a high-priority transmission queue.

9. The method of claim 1, further comprising discovering codec capabilities of endpoints in an IP Multimedia Subsystem (IMS) or Session Initiation Protocol (SIP) network of the NB-IoT satellite NTN, comprising:
receiving a SIP REGISTER message from a registering wireless device registering with an IMS network, wherein the IMS network is at an application layer at the core network of the NB-IoT NTN to access support call session control);
inspecting one or more SIP headers included in the SIP REGISTER message, the headers comprising at least one of a User-Agent header, device-type identifier, or vendor-specific extension;
mapping the inspected one or more SIP headers to a known device profile associated with codec capability information;
determining codec capabilities of the registering wireless device based on the mapped device profile; and
using the determined codec capabilities to select a codec for use in a call between the UE and a remote endpoint.

10. The method of claim 9, wherein the mapping is performed using a codec profile database, the database storing predefined codec capability profiles corresponding to known device types.

11. The method of claim 9, further comprising:
transmitting, by the wireless device, a SIP OPTIONS request to a remote endpoint;
receiving, by the wireless device, a SIP OPTIONS response including a Session Description Protocol (SDP) body identifying one or more codecs supported by the remote endpoint; and
selecting, by the wireless device, a codec for use in a subsequent call based on the supported codecs listed in the SDP body.

12. The method of claim 1, further comprising determining codec capabilities of the wireless device using static device profiles, comprising:
storing, by the core network, a plurality of static device profiles in a codec capability database, each profile including a list of supported codecs for a corresponding device type;
identifying, by the core network, a device type of the UE from a SIP REGISTER or SIP INVITE message;
matching, by the core network, the identified device type to a corresponding static device profile; and
selecting, by the core network, a codec for use in a session involving the wireless device based on the matched device profile.

13. The method of claim 1, further comprising inferring codec capabilities of an endpoint based on historical data, comprising:
maintaining, by the core network, a cache of codec usage history for one or more endpoints;
identifying, by the core network a previously used codec for a given endpoint from the history cache; and
selecting, by the core network the previously used codec as a preferred codec for a new call involving the same endpoint.

14. The method of claim 1, further comprising determining codec capabilities of endpoints in the NB-IoT satellite NTN, comprising:
inspecting, by a SIP Back-to-Back User Agent (B2BUA) Interworking Function (IWF) of the core network, SIP REGISTER messages, SIP OPTIONS messages, or previously stored device profiles;
storing, by a database of the core network, static device profiles and/or codec usage history for multiple endpoints;
determining, by a codec selection module of the core network, codec capabilities from inspected SIP headers, SIP OPTIONS responses, or stored profiles; and
initiating or managing, by a communication interface of the core network, a call between endpoints using a codec selected by the codec selection module.

15. The method of claim 1, further comprising minimizing codec negotiation delays, comprising:
sending, by the wireless device, a SIP OPTIONS request to a target endpoint of the core network, the base station, a core network node, or an IWF node of the core network;
receiving, by another wireless device, the core network node, or the IWF node of the core network, a SIP OPTIONS response including an SDP body that identifies supported codecs back from the target endpoint of the core network;
storing, by the wireless device, the core network node, or the IWF node of the core network, the identified codec list in a local cache; and
retrieving, by another wireless device, the core network node, or the IWF node of the core network, the cached codec list for future session setups with the same endpoint, thereby reducing the need for repeated codec negotiation.

16. The method of claim 1, further comprising enhancing Real-Time Transport Protocol (RTP) packet transmission over a wireless interface between the wireless device and the base station, comprising:
receiving, at the base station, a core network node, or an interworking function of the core network, a reduced RTP packet from the wireless device, wherein the reduced RTP packet omits at least one original RTP header field;
generating, by the base station, the core network node, or the interworking function of the core network, one or more information elements (IEs) comprising supplementary metadata associated with the reduced RTP packet; and
prepending the base station, the core network node, or the interworking function of the core network, the one or more information elements to the reduced RTP packet to form an enhanced RTP packet for downstream processing or delivery.

17. The method of claim 16, wherein each of the one or more information elements comprises an IE header including:
an extension (E) bit indicating whether additional information elements follow;
a comprehension (C) bit indicating whether the information element is mandatory for correct decoding;
an information element (IE) type field identifying the semantic category of the information element;
a reserved field for future extensions; and
a length field specifying the length of the IE body in octets.

18. The method of claim 17, wherein each information element (IE) further comprises an IE body, a content of which is determined based on a corresponding IE type field.

19. The method of claim 1, further comprising enhancing RTP packet delivery, comprising:
generating and transmitting, by the wireless device, reduced RTP packets over a wireless interface between the wireless device and the base station;
receiving, by the base station, a core network node, or an interworking function of the core network, the reduced RTP packets;
generating, by the base station, the core network node, or the interworking function of the core network, one or more information elements comprising metadata associated with the original RTP structure; and
prepending, by the base station, the core network node, or the interworking function of the core network, the one or more information elements to the reduced RTP packet to produce an enhanced RTP packet.

20. A Narrowband Internet-of-things (NB-IoT) Satellite Non-Terrestrial Network (NTN) comprising:
a core network,
a base station,
a wireless device,
the core network configured to:
establish for each IMS session of a plurality of IMS sessions, two separate Data Radio Bearers (DRBs) including a first DRB for transporting signaling traffic and a second DRB for transporting voice media packets, wherein a base station of the satellite network prioritizes the voice media packets over the second DRB to reduce latency and jitter, wherein the first DRB is mapped to a default Evolved Packet System (EPS) bearer and communicated over a wireless link to a wireless device and the second DRB is mapped to a dedicated EPS bearer and communicated over the wireless link to the wireless device;
the wireless device is configured to:
establish the two separate DRBs for an IMS voice session including the first DRB for transporting the signaling traffic and a second DRB for transporting the voice media packets;
send, by a data transport of the wireless device, at least one of the signaling traffic or the voice media packets with non-IP packets;
configure a radio link control (RLC) acknowledged mode for the signaling traffic and an unacknowledged mode for the voice media packets; and
initiate, by a control module of the wireless device, an IMS session setup using signaling, wherein the signal includes messages to support call set up, release, modifications, and call registration, and wherein the signaling traffic includes data streams that include the messages.
